(19) United States
(12) Patent Application Publication
(10) Pub. No.: US 2026/0110813 A1
(43) Pub. Date: Apr. 23, 2026

(54) SUBSURFACE CO2 OPERATIONAL FRAMEWORK

(71) Applicants: SCHLUMBERGER TECHNOLOGY CORPORATION, Sugar Land, TX (US); CHEVRON U.S.A. INC., San Ramon, CA (US); TOTALENERGIERS ONETECH, Courbevoie (FR)

(72) Inventor: Mehdi Paydayesh, Crawley (GB)

(21) Appl. No.: 19/154,393

(22) PCT Filed: Jun. 21, 2024
(86) PCT No.: PCT/US2024/035057

§ 371 Date: Aug. 7, 2025

Related U.S. Application Data
(60) Provisional application No. 63/509,881, filed on Jun. 23, 2023.

(51) Int. Cl. G01V 1/30; G01V 1/28

(52) U.S. Cl. CPC G01V 1/306; G01V 1/282; G01V 1/303

(57) ABSTRACT

A method can include determining carbon dioxide acoustic properties for at least supercritical carbon dioxide using thermodynamics that relate isothermal compressibility and adiabatic compressibility: determining fluid-saturated rock acoustic properties using the carbon dioxide acoustic properties; and performing a seismic workflow using the fluid-saturated rock acoustic properties.

### RELATED APPLICATIONS

This application claims priority to and the benefit of a US Provisional Application having Ser. No. 63/509,881, filed 23 Jun. 2023, which is incorporated by reference herein in its entirety.

### BACKGROUND

Carbon capture, utilization, and storage (CCUS) can facilitate efforts toward greenhouse gas (GHG) emissions to the atmosphere and toward carbon neutrality. As an example, CO2 can be captured from a power station, an industrial source (e.g., cement factory, etc.), from natural gas production, etc. CO2 can be utilized in chemical processes, ranging from fertilizer to food production, and in enhanced oil recovery (EOR) and enhanced gas recovery (EGR), or it can be sequestered in geological structures, including saline aquifers, depleted oil and gas reservoirs, deep coal beds, etc.

As to reservoirs, a reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.).

In various CO2 storage operations, a workflow can integrate aspects of CO2 storage and reservoir technologies. As an example, CO2 storage operations can depend on reservoir capacity (e.g., amount of CO2 that can be stored), reservoir injectivity (e.g., possible injection rates), and reservoir containment (e.g., stability of storage and/or risks of leakage).

CO2 operations demand an assessment of complex physical and chemical behavior of CO2 where, for example, CO2 may be a component of a hydrocarbon phase and/or an aqueous phase. Above the critical point (e.g., a temperature of 31 degrees Celsius and pressure of 73.8 bar) pure CO2 exists as a supercritical dense state, with gas-like viscosity and liquid-like density; whereas, below the critical point, physical properties can differ (e.g., consider CO2 as a gas or a liquid). Where oil is present, injected CO2 can become miscible with oil at high pressures. Where water is present, CO2 solubility in an aqueous phase can depend on reservoir conditions and brine composition, noting that solubility tends to increase with decreasing temperature and/or with increasing pressure and tends to decrease with increasing brine salinity.

As an example, CO2 injected into a storage site may form a gaseous plume that migrates underground, influenced by pressure gradients, gravity and buoyancy forces. CO2 may be trapped in a subsurface environment by one or more of various mechanisms, which may act over different timescales. For example, consider structural trapping where gaseous CO2 can be trapped by cap rock and/or structural features (e.g., relevant in injection and post-injection phases while gas is highly mobile); residual trapping where the gas phase is immobilized due to effects of relative permeability and capillary pressure (e.g., relevant in injection and post-injection phases while gas remains mobile); solubility trapping where CO2 dissolves into an aqueous phase (e.g., a slower process that can take hundreds or thousands of years to complete); and mineral trapping where acid formed by CO2 dissolution reacts with the reservoir rock and mineral generation occurs (e.g., a long-term process that can take many thousands of years to complete).

Interactions between CO2, water, and salts can affect solubility trapping and mineral trapping in the long term along with injectivity due to near-wellbore behavior. As CO2 gas is injected, H2O in brine can evaporate into CO2 resulting in “dry-out” in the region near the injection well, when residual water saturation can reduce to zero. This tends to increase effective permeability to CO2 such that injectivity can increase. On the other hand, in high-salinity brine there is a risk of “salting-out” as H2O evaporates. Increasing salinity can lead to halite precipitation such that permeability and porosity are reduced with an accompanying decrease in injectivity.

Total CO2 injection from worldwide CCUS projects continues to grow. To meet future goals, there will be an increase in CO2 storage activities, which will depend on selection of suitable sites, design of injection and monitoring strategies, and effective management of costs and risks.

To perform one or more CCUS operations, various workflows may be implemented. For example, consider workflows for site selection, appraisal and planning, to operations and surveillance. Workflows can involve assessments as to CO2 projects, ranging from design and construction of observation wells to 4D seismic survey monitoring and dynamic simulation of storage scenarios. 4D seismic involves performing 3D seismic surveys with respect to time, where time is the fourth dimension. The performance of such surveys, and analysis of acquired seismic survey data, demands an understanding of acoustic properties of CO2 and acoustic properties of mixtures of CO2 and hydrocarbons and/or water, particularly within one or more types of rock (e.g., consider saturated rock). With knowledge of such acoustic properties, CO2 storage workflows that integrate reservoir modeling and seismic surveying can be improved. For example, consider a CO2 storage workflow that includes reservoir simulation of injection and storage along with matching simulation results to measured field data and/or 4D seismic survey data (e.g., history matching), which can provide for improved CO2 storage operation planning and execution. Such improvements can pertain to site selection, site preparation, reservoir simulation, sensitivity analysis, seismic survey planning, seismic survey execution, seismic survey interpretation, etc.

As explained, CO2 may be injected into a subsurface reservoir that includes hydrocarbon fluids, which may be referred to as hydrocarbons. Where present, CO2, hydrocarbons, and water can be characterized in various manners. For example, their behavior can be characterized via pressure, volume and temperature analysis (PVT analysis), which can involve analysis of phase diagrams (e.g., phase plots). In a reservoir, variables such as pressure and temperature can differ spatially, which can give rise to different phases, that may be characterized as gas or liquid phases or, for example, supercritical states where properties may differ from subcritical state properties.

In a reservoir, fluid may include multiple components such as, for example, a range of hydrocarbons that can be classified according to number of carbon atoms, number of hydrogen atoms, etc. The accumulation of hydrocarbons in a reservoir can be a process that occurs over many years such that at present time (e.g., consider a time span of reservoir exploration, development and production), reservoir fluid may appear to be in an equilibrium state. Upon injection of CO2 into a reservoir, reservoir fluid and CO2 may mix, which can result in subsurface regions of mixed fluids with properties that differ from preexisting reservoir fluids.

As mentioned, seismic surveys may be performed where seismic energy (e.g., acoustic energy) interacts with rocks and fluids within the rocks. A seismic workflow can involve generation of a velocity model of a subsurface region where the velocity model includes acoustic velocities of one or more types of subsurface rock, which may be fluid saturated with different fluids (e.g., components, compositions, etc.). Accordingly, where CO2 is present and spatially distributed in the subsurface region, which may be in a supercritical state and/or a subcritical state, acoustic velocities can depend on CO2 and its state. Seismic surveying and related analyses (e.g., interpretation, history matching, etc.) can be improved where CO2 is adequately accounted for in a subsurface region.

In various reservoir simulation workflows, an interactive application such as a PVT application may be utilized. Such workflows can involve analysis of fluid samples, equations of state (EoSs), and estimating fluid variations with respect to depth and/or one or more other dimensions. Where CO2 injection and storage are to be taken into account, as with seismic workflows, CO2 may be spatially distributed in a supercritical state and/or a subcritical state. Reservoir simulation and related analyses (e.g., history matching, production, operational control, etc.) can also be improved where CO2 is adequately accounted for in a subsurface region.

As explained, seismic workflows and reservoir simulation workflows can be improved by appropriately accounting for CO2, which may be spatially distributed, unmixed and/or mixed, and in a supercritical state and/or a subcritical state. In various examples, a subsurface CO2 operational framework can account for CO2 to improve one or more workflows and associated field operations.

### SUMMARY

A method can include determining carbon dioxide acoustic properties for at least supercritical carbon dioxide using thermodynamics that relate isothermal compressibility and adiabatic compressibility; determining fluid-saturated rock acoustic properties using the carbon dioxide acoustic properties; and performing a seismic workflow using the fluid-saturated rock acoustic properties.

A system can include a processor; a memory accessibly by the processor; and instructions stored in the memory and executable by the processor to instruct the system to: determine carbon dioxide acoustic properties for at least supercritical carbon dioxide using thermodynamics that relate isothermal compressibility and adiabatic compressibility; determine fluid-saturated rock acoustic properties using the carbon dioxide acoustic properties; and perform a seismic workflow using the fluid-saturated rock acoustic properties.

One or more computer-readable storage media can include processor-executable instructions wherein the processor-executable instructions comprise instructions to instruct a computing system to: determine carbon dioxide acoustic properties for at least supercritical carbon dioxide using thermodynamics that relate isothermal compressibility and adiabatic compressibility; determine fluid-saturated rock acoustic properties using the carbon dioxide acoustic properties; and perform a seismic workflow using the fluid-saturated rock acoustic properties.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a system and examples of equipment in a geologic environment;

FIG. 2 illustrates examples of equipment in a geologic environment and an example of a system;

FIG. 3 illustrates an example of a system;

FIG. 4 illustrates an example of a system with respect to an example of a geologic environment;

FIG. 5 illustrates an example of a system with respect to an example of a geologic environment;

FIG. 6 illustrates an example of a CO2 phase diagram;

FIG. 7 illustrates an example of a method;

FIG. 8 illustrates an example of a method;

FIG. 9 illustrates an example of a phase diagram;

FIG. 10 illustrates examples of graphical user interfaces;

FIG. 11 illustrates examples of techniques for seismic data acquisition and analysis;

FIG. 12 illustrates an example of forward modeling and an example of inversion;

FIG. 13 illustrates an example of a method;

FIG. 14 illustrates an example of a framework;

FIG. 15 illustrates an example of a framework;

FIG. 16 illustrates an example of a workflow;

FIG. 17 illustrates an example of a framework;

FIG. 18 illustrates an example of a method and an example of a system; and

FIG. 19 illustrates example components of a system and a networked system.

### DETAILED DESCRIPTION

As explained, CO2 CCSU operations can rely on performing one or more of various workflows that can be improved through use of a subsurface CO2 operational framework that can account for subsurface CO2. As an example, such a framework can implement a method for thermodynamically driven computation of fluid acoustic properties for CO2 modeling where, for example, the results thereof may be integrated into a simulation to seismic (Sim2Seis) workflow.

As an example, a framework can include components for implementing a method for accurately computing acoustic properties of fluid mixtures within the context of rock physics modelling for carbon capture and storage operations. In such an example, the framework may integrate one or more EoSs with experimental data (e.g., laboratory data, etc.). As an example, a method can be executed by the framework to identify a most predictive EoS for determining sound velocity (e.g., acoustic velocity) in one or more fluid mixtures. For example, consider a framework that can evaluate multiple EoSs that can include, for example, the Peng Robinson EoS and the Soave-Redlich-Kwong (SRK). In such an example, a selected EoS can be integrated into a rock physics modelling framework, which can thereby enable accurate predictions of acoustic properties for fluid mixtures, where fluids and/or fluid mixtures can include CO2. As an example, a subsurface CO2 operational framework can improve CCS modelling, facilitate improved characterization of subsurface reservoirs, and enhance effectiveness of carbon storage efforts.

As explained, CO2 injection can change composition of fluids that are in place in a subsurface region. In various CO2 storage reservoirs, the pressure and temperature regime will be, by design, such that injected CO2 will exist in the supercritical state of its phase diagram, thus having complex supercritical physical properties of gas and liquid. In contrast, when CO2 is injected in a depleted hydrocarbon reservoir, the CO2 can mix with residual oil and/or gas. For both cases equations present in an article by Batzle and Wang (“Seismic properties of pore fluids”, Geophysics, 57, 11, pp. 1396-1408, 1992, which is incorporated by reference herein in its entirety), often find use in computing fluid acoustic parameters; however, such an approach is not valid. Hence, to improve CO2 workflows, a framework can be implemented that employs fluid thermodynamics and an EoS that may be calibrated with experimental laboratory data. Using such a framework, the predictability of rock physics modelling, and subsequent seismic modeling are improved. Results from an example, trial 1D modeling workflow implemented in 3D modeling for simulation to seismic (Sim2Seis) modelling demonstrates improved results, particularly in view of the shortcomings of the Batzle and Wang equations. As explained, a framework can provide for thermodynamically driven fluid acoustic properties within a Sim2Seis workflow involve CO2.

As an example, a subsurface CO2 operational framework can provide for accurately computing fluid acoustic properties for CCS modeling, for example, by considering changes in fluid composition resulting from CO2 injection. Such a framework can employ fluid thermodynamics and an EoS that may be calibrated with experimental laboratory data. Such an approach can overcome shortcomings of equations such as those presented in Batzle and Wang (1992), which are inadequate for characterizing supercritical CO2 and/or CO2 mixed with residual oil and/or gas. A framework can be implemented to enhance predictability of rock physics modeling and subsequent seismic modeling in a manner that improves accuracy of simulation to seismic workflows (Sim2Seis).

Below, various examples of systems, frameworks, components, methods, etc., are described that may be utilized in one or more CO2 related operations.

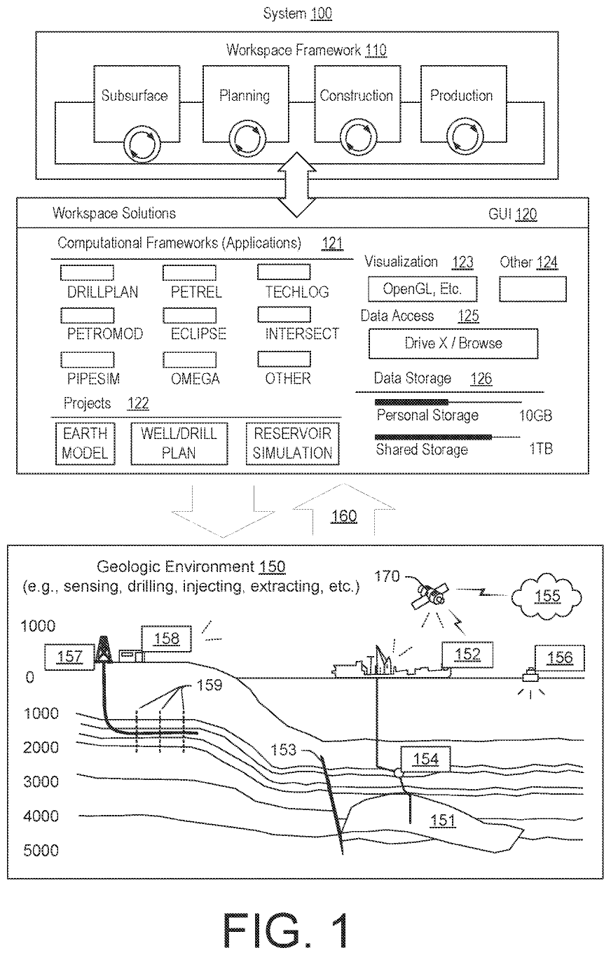

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite 170 in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As an example, a system may include a computational environment that can include various features of the DELFI environment (SLB, Houston, Texas), which may be referred to as the DELFI framework, which may be a framework of frameworks. As an example, the DELFI framework can include various other frameworks, which can include, for example, one or more types of models (e.g., simulation models, etc.). Some examples of frameworks can include the DRILLPLAN, DRILLOPS, PETREL, TECHLOG, PIPESIM, ECLIPSE, INTERSECT, KINETIX, VISAGE, MANGROVE, OMEGA and PETROMOD frameworks (SLB, Houston, Texas).

As an example, a system may include features of a simulation framework that provides components that allow for optimization of exploration and development operations (e.g., “E&P” operations). A framework may include seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of simulating a geologic environment, decision making, operational control, etc.).

As an example, a system may include add-ons or plug-ins that operate according to specifications of a framework environment. As an example, various components may be implemented as add-ons (or plug-ins) that conform to and operate according to specifications of a framework environment (e.g., according to application programming interface (API) specifications, etc.).

The aforementioned DELFI environment is a secure, cognitive, cloud-based collaborative environment that integrates data and workflows with digital technologies, such as artificial intelligence and machine learning. As an example, such an environment can provide for operations that involve one or more computational frameworks. For example, various types of computational frameworks may be utilized within an environment such as a drilling plan framework, a seismic-to-simulation framework, a measurements framework, a mechanical earth modeling (MEM) framework, an exploration risk, resource, and value assessment framework, a reservoir simulation framework, a surface facilities framework, a stimulation framework, etc. As an example, one or more methods may be implemented at least in part via a framework (e.g., a computational framework) and/or an environment (e.g., a computational environment).

In the example of FIG. 1, the GUI 120 shows some examples of computational frameworks, including the DRILLPLAN, PETREL, TECHLOG, PETROMOD, ECLIPSE, INTERSECT, PIPESIM and OMEGA frameworks that may be part of a DELFI environment.

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can provide for implementing various tasks in geosciences and geoengineering, for example, to analyze subsurface data from exploration to production of fluid from a reservoir.

The TECHLOG framework can handle and process field and laboratory data for a variety of geologic environments (e.g., deepwater exploration, shale, etc.). The TECHLOG framework can structure wellbore data for analyses, planning, etc.

The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (chemical EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI environment, for example, for rapid simulation of multiple concurrent cases. For example, a workflow may utilize one or more of the DELFI on demand reservoir simulation features.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (SLB, Houston Texas). As an example, a reservoir or reservoirs may be simulated with respect to one or more enhanced recovery techniques (e.g., consider a thermal process such as steam-assisted gravity drainage (SAGD), etc.). As an example, the PIPESIM simulator may be an optimizer that can optimize one or more operational scenarios at least in part via simulation of physical phenomena.

The OMEGA framework includes finite difference modelling (FDMOD) features for two-way wavefield extrapolation modelling, generating synthetic shot gathers with and without multiples. The FDMOD features can generate synthetic shot gathers by using full 3D, two-way wavefield extrapolation modelling, which can utilize wavefield extrapolation logic matches that are used by reverse-time migration (RTM). A model may be specified on a dense 3D grid as velocity and optionally as anisotropy, dip, and variable density. The OMEGA framework also includes features for RTM, FDMOD, adaptive beam migration (ABM), Gaussian packet migration (Gaussian PM), depth processing (e.g., Kirchhoff prestack depth migration (KPSDM), tomography (Tomo)), time processing (e.g., Kirchhoff prestack time migration (KPSTM), general surface multiple prediction (GSMP), extended interbed multiple prediction (XIMP)), framework foundation features, desktop features (e.g., GUls, etc.), and development tools. Various features can be included for processing various types of data such as, for example, one or more of: land, marine, and transition zone data; time and depth data; 2D, 3D, and 4D surveys; isotropic and anisotropic (TTI and VTI) velocity fields; and multicomponent data.

As to the aforementioned DRILLOPS framework, it may execute a digital drilling plan and ensure plan adherence, while delivering goal-based automation. Automation may utilize data analysis and learning systems to assist and optimize tasks, such as, for example, setting ROP to drilling a stand. A preset menu of automatable drilling tasks may be rendered, and, using data analysis and/or models, a plan may be executed in a manner to achieve a specified goal, where, for example, measurements may be utilized for calibration. The DRILLOPS framework provides flexibility to modify and replan activities dynamically, for example, based on a live appraisal of various factors (e.g., equipment, data, personnel, and supplies). Well construction activities (e.g., tripping, drilling, cementing, etc.) may be continually monitored and dynamically updated using feedback from operational activities. The DRILLOPS framework may provide for various levels of automation based on planning and/or re-planning (e.g., via the DRILLPLAN framework), feedback, etc.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.).

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, a visualization process can implement one or more of various features that can be suitable for one or more web applications. For example, a template may involve use of the JAVASCRIPT object notation format (JSON) and/or one or more other languages/formats. As an example, a framework may include one or more converters. For example, consider a JSON to PYTHON converter and/or a PYTHON to JSON converter. Such a converter may provide for interoperability, integration of code from one or more sources, etc.

As an example, visualization features can provide for visualization of various earth models, properties, etc., in one or more dimensions. As an example, visualization features can provide for rendering of information in multiple dimensions, which may optionally include multiple resolution rendering. In such an example, information being rendered may be associated with one or more frameworks and/or one or more data stores. As an example, visualization features may include one or more control features for control of equipment, which can include, for example, field equipment that can perform one or more field operations. As an example, a workflow may utilize one or more frameworks to generate information that can be utilized to control one or more types of field equipment (e.g., drilling equipment, wireline equipment, fracturing equipment, etc.). As an example, a visualization framework such as the OpenGL framework (The Khronos Group, Inc., Beaverton, Oregon) may be utilized for visualizations. The OpenGL framework provides a cross-language, cross-platform application programming interface for rendering 2D and 3D vector graphics where the API may be used to interact with a graphics processing unit (or units), to achieve hardware-accelerated rendering.

As to a reservoir model that may be suitable for utilization by a simulator, consider acquisition of seismic data as acquired via reflection seismology, which finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.).

Field acquisition equipment may be utilized to acquire seismic data, which may be in the form of traces where a trace can include values organized with respect to time and/or depth (e.g., consider 1D, 2D, 3D or 4D seismic data). For example, consider acquisition equipment that acquires digital samples at a rate of one sample per approximately 4 ms. Given a speed of sound in a medium or media, a sample rate may be converted to an approximate distance. For example, the speed of sound in rock may be on the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, a deepest boundary depth may be estimated to be about 10 km (e.g., assuming a speed of sound of about 5 km per second).

As an example, a model may be a simulated version of a geologic environment. As an example, a simulator may include features for simulating physical phenomena in a geologic environment based at least in part on a model or models. A simulator, such as a reservoir simulator, can simulate fluid flow in a geologic environment based at least in part on a model that can be generated via a framework that receives seismic data. A simulator can be a computerized system (e.g., a computing system) that can execute instructions using one or more processors to solve a system of equations that describe physical phenomena subject to various constraints. In such an example, the system of equations may be spatially defined (e.g., numerically discretized) according to a spatial model that that includes layers of rock, geobodies, etc., that have corresponding positions that can be based on interpretation of seismic and/or other data. A spatial model may be a cell-based model where cells are defined by a grid (e.g., a mesh). A cell in a cell-based model can represent a physical area or volume in a geologic environment where the cell can be assigned physical properties (e.g., permeability, fluid properties, etc.) that may be germane to one or more physical phenomena (e.g., fluid volume, fluid flow, pressure, etc.). A reservoir simulation model can be a spatial model that may be cell-based.

A simulator can be utilized to simulate the exploitation of a real reservoir, for example, to examine different production scenarios to find an optimal one before production or further production occurs. While production scenarios are mentioned, a simulator may provide for simulation of various injection scenarios; noting that a simulator may provide for simulation of injection and production scenarios. In various instances, a reservoir simulator may not provide an exact replica of flow in and production from a reservoir at least in part because a description of the reservoir and boundary conditions for equations for flow in a porous rock are generally known with an amount of uncertainty. Further, certain types of physical phenomena occur at a spatial scale that can be relatively small compared to size of a field. As an example, a balance may be struck between model scale and computational resources that results in model cell sizes being of the order of meters; rather than a lesser size (e.g., a level of detail of pores). A modeling and simulation workflow for multiphase flow in porous media (e.g., reservoir rock, etc.) can include generalizing real micro-scale data from macro scale observations (e.g., seismic data and well data) and upscaling to a manageable scale and problem size. Uncertainties can exist in input data and solution procedure such that simulation results too are to some extent uncertain. In various instances, a simulator may proceed iteratively in a manner that aims to reduce error at each iteration to converge to a solution. At times convergence to a global, meaningful solution may not be guaranteed given problem complexities, which may be due in part to nonlinearities within fundamental equations that aim to represent various types of physical phenomena. Further, a simulation model may include millions of unknowns, which can result in large matrixes where numerical issues may possibly confound convergence. As an example, to help constrain and/or quality control a simulation, a process known as history matching may be employed. For example, history matching can involve comparing simulation results to actual field data acquired during production and/or injection of fluid with respect to a field. Information gleaned from history matching, can provide for adjustments to a model, data, etc., which can help to increase accuracy of simulation. As an example, history matching may be performed on a particular basis, for example, as field data become available to improve simulation, improve predictions as to future behavior, to consider possible scenarios, etc. As an example, simulations may provide for improved control of field operations, drilling of one or more additional wells, injection of fluid, production of fluid, etc.

As an example, a simulator may utilize various types of constructs, which may be referred to as entities. Entities may include earth entities or geological objects such as wells, surfaces, reservoirs, etc. Entities can include virtual representations of actual physical entities that may be reconstructed for purposes of simulation. Entities may include entities based on data acquired via sensing, observation, etc. (e.g., consider entities based at least in part on seismic data and/or other information). As an example, an entity may be characterized by one or more properties (e.g., a geometrical pillar grid entity of an earth model may be characterized by a porosity property, etc.). Such properties may represent one or more measurements (e.g., acquired data), calculations, etc.

As an example, a simulator may utilize an object-based software framework, which may include entities based on pre-defined classes to facilitate modeling and simulation. As an example, an object class can encapsulate reusable code and associated data structures. Object classes can be used to instantiate object instances for use by a program, script, etc. For example, borehole classes may define objects for representing boreholes based on well data. A model of a basin, a reservoir, etc. may include one or more boreholes where a borehole may be, for example, for measurements, injection, production, etc. As an example, a borehole may be a wellbore of a well, which may be a completed well (e.g., for production of a resource from a reservoir, for injection of material, etc.).

While several simulators are illustrated in the example of FIG. 1, one or more other simulators may be utilized, additionally or alternatively. For example, consider the KINETIX reservoir-centric stimulation-to-production framework that may efficiently integrate geology, petrophysics, completion engineering, reservoir engineering, and geomechanics to optimize field operations, which may include, for example, one or more of completion operations, fracturing operations, etc., whether for a well, a pad, or a field. The KINETIX framework may be operatively coupled to the PETREL framework. Further, the KINETIX framework may utilize logs, geometric completions, 3D mechanical and petrophysical models in a manner coupled with INTERSECT high-resolution reservoir simulator and/or the VISAGE finite-element geomechanics simulator. With automated parallel processing (e.g., using a cloud platform), the KINETIX framework may provide for rapid assessment of well spacing, completion, and treatment designs (e.g., an ability to run thousands of scenarios in hours rather than weeks).

The VISAGE simulator includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO2 operations, etc. The MANGROVE simulator provides for optimization of stimulation design (e.g., stimulation treatment operations such as hydraulic fracturing) in a reservoir-centric environment. The MANGROVE framework can combine scientific and experimental work to predict geomechanical propagation of hydraulic fractures, reactivation of natural fractures, etc., along with production forecasts within 3D reservoir models (e.g., production from a drainage area of a reservoir where fluid moves via one or more types of fractures to a well and/or from a well). The MANGROVE framework can provide results pertaining to heterogeneous interactions between hydraulic and natural fracture networks, which may assist with optimization of the number and location of fracture treatment stages (e.g., stimulation treatment(s)), for example, to increased perforation efficiency and recovery.

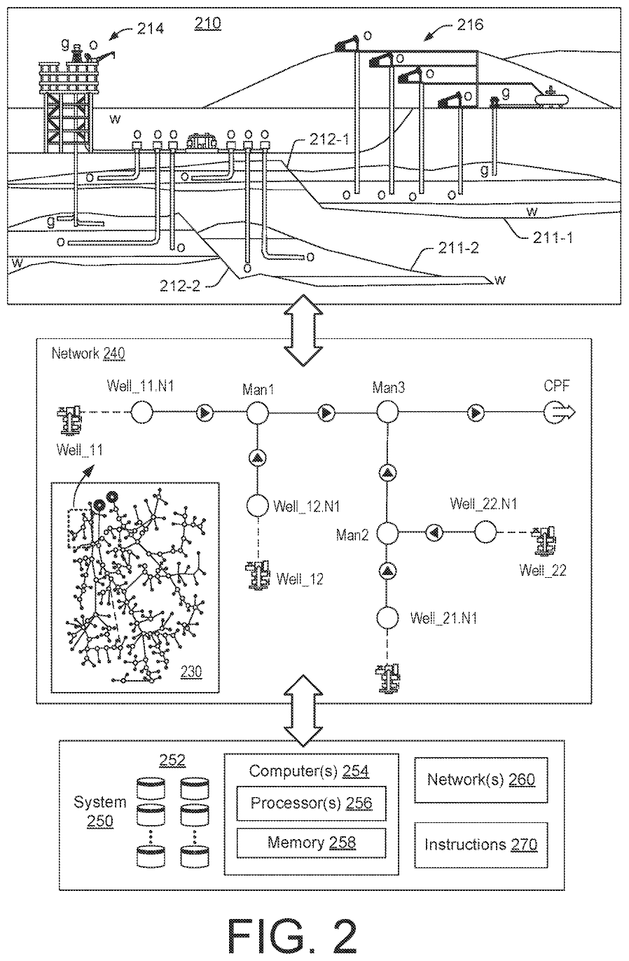

FIG. 2 shows an example of a geologic environment 210 that includes reservoirs 211-1 and 211-2, which may be faulted by faults 212-1 and 212-2, an example of a network of equipment 230, an enlarged view of a portion of the network of equipment 230, referred to as network 240, and an example of a system 250. FIG. 2 shows some examples of offshore equipment 214 for oil and gas operations related to the reservoir 211-2 and onshore equipment 216 for oil and gas operations related to the reservoir 211-1.

In FIG. 2, the network 240 can be an example of a relatively small production system network. As shown, the network 240 forms somewhat of a tree like structure where flowlines represent branches (e.g., segments) and junctions represent nodes. As shown in FIG. 2, the network 240 provides for transportation of oil and gas fluids from well locations along flowlines interconnected at junctions with final delivery at a central processing facility.

In the example of FIG. 2, various portions of the network 240 may include conduit (e.g., pipe, pipelines, etc.). For example, consider a perspective view of a geologic environment that includes two conduits which may be a conduit to a manifold (Man1) and a conduit to another manifold (Man3) in the network 240. As shown, the network 240 may include a central processing facility (CPF) that may process fluid produced from one or more wells. As an example, one or more compressors may be present within a network, which may consume energy. As an example, energy may be provided from one or more sources such as, for example, a utility grid, combustible fuel (e.g., to power internal combustion engines, whether piston, turbine, or other), etc. While the network 240 include production wells, as an example, a network may include one or more injection wells.

As shown in FIG. 2, the example system 250 includes one or more information storage devices 252, one or more computers 254, one or more networks 260 and instructions 270 (e.g., organized as one or more sets of instructions). As to the one or more computers 254, each computer may include one or more processors (e.g., or processing cores) 256 and memory 258 for storing the instructions 270 (e.g., one or more sets of instructions), for example, executable by at least one of the one or more processors. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 252. As an example, information that may be stored in one or more of the storage devices 252 may include information about equipment, location of equipment, orientation of equipment, fluid characteristics, etc.

As an example, the instructions 270 can include instructions (e.g., stored in the memory 258) executable by at least one of the one or more processors 256 to instruct the system 250 to perform various actions. As an example, the system 250 may be configured such that the instructions 270 provide for establishing a framework, for example, that can perform network modeling (see, e.g., the PIPESIM framework of the example of FIG. 1, etc.) and/or one or more other types of modeling. As an example, one or more methods, techniques, etc. may be performed using one or more sets of instructions, which may be, for example, the instructions 270 of FIG. 2.

As an example, a model may be made that models a geologic environment in combination with equipment, wells, etc. For example, a model may be a flow simulation model for use by a simulator to simulate flow in an oil, gas or oil and gas production system. Such a flow simulation model may include equations, for example, to model multiphase flow from a reservoir to a wellhead, from a wellhead to a reservoir, etc. A flow simulation model may also include equations that account for flowline and surface facility performance, for example, to perform a comprehensive production system analysis.

As an example, a flow simulation model may be a network model that includes various sub-networks specified using nodes, segments, branches, etc. As an example, a flow simulation model may be specified in a manner that provides for modeling of branched segments, multilateral segments, complex completions, intelligent downhole controls, etc. As an example, one or more portions of a production network (e.g., optionally sub-networks, etc.) or a group of signal components and/or controllers may be modeled as sub-models.

As an example, a system may provide for transportation of oil and gas fluids from well locations to processing facilities and may represent a substantial investment in infrastructure with both economic and environmental impact. Simulation of such a system, which may include hundreds or thousands of flow lines and production equipment interconnected at junctions to form a network, can involve multiphase flow science and, for example, use of engineering and mathematical techniques for large systems of equations.

As an example, a flow simulation model may include equations for performing nodal analysis, pressure-volume-temperature (PVT) analysis, gas lift analysis, erosion analysis, corrosion analysis, production analysis, injection analysis, etc. In such an example, one or more analyses may be based, in part, on a simulation of flow in a modeled network.

As to nodal analysis, it may provide for evaluation of well performance, for making decisions as to completions, etc. A nodal analysis may provide for an understanding of behavior of a system and optionally sensitivity of a system (e.g., production, injection, production and injection). For example, a system variable may be selected for investigation and a sensitivity analysis performed. Such an analysis may include plotting inflow and outflow of fluid at a nodal point or nodal points in the system, which may indicate where certain opportunities exist (e.g., for injection, for production, etc.).

A modeling framework may include instructions (e.g., processor-executable instructions) to facilitate generation of a flow simulation model. For example, instructions may provide for modeling completions for vertical wells, completions for horizontal wells, completions for fractured wells, etc. A modeling framework may include instructions for particular types of equations, for example, black-oil equations, EoSs, etc. A modeling framework may include instructions for artificial lift, for example, to model fluid injection, fluid pumping, etc. As an example, consider a set of instructions (e.g., a component) that includes features for modeling one or more electric submersible pumps (ESPs) (e.g., based in part on pump performance curves, motors, cables, etc.).

As an example, an analysis using a flow simulation model may be a network analysis to: identify production bottlenecks and constraints; assess benefits of new wells, additional pipelines, compression systems, etc.; calculate deliverability from field gathering systems; predict pressure and temperature profiles through flow paths; or plan full-field development.

As an example, a flow simulation model may provide for analyses with respect to future times, for example, to allow for optimization of production equipment, injection equipment, etc. As an example, consider an optimal time-based and conditional-event logic representation for daily field development operations that can be used to evaluate drilling of new developmental wells, installing additional processing facilities over time, choke-adjusted wells to meet production and operating limits, shutting in of depleting wells as reservoir conditions decline, etc.

As to equations, sets of conservation equations for mass momentum and energy describing single, two or three phase flow (e.g., according to one or more of a LEDAFLOW (Kongsberg Oil & Gas Technologies AS, Sandvika, Norway), OLGA model (SLB, Houston, Texas), TUFFP unified mechanistic models (Tulsa University Fluid Flow Projects, Tulsa, Oklahoma), etc.).

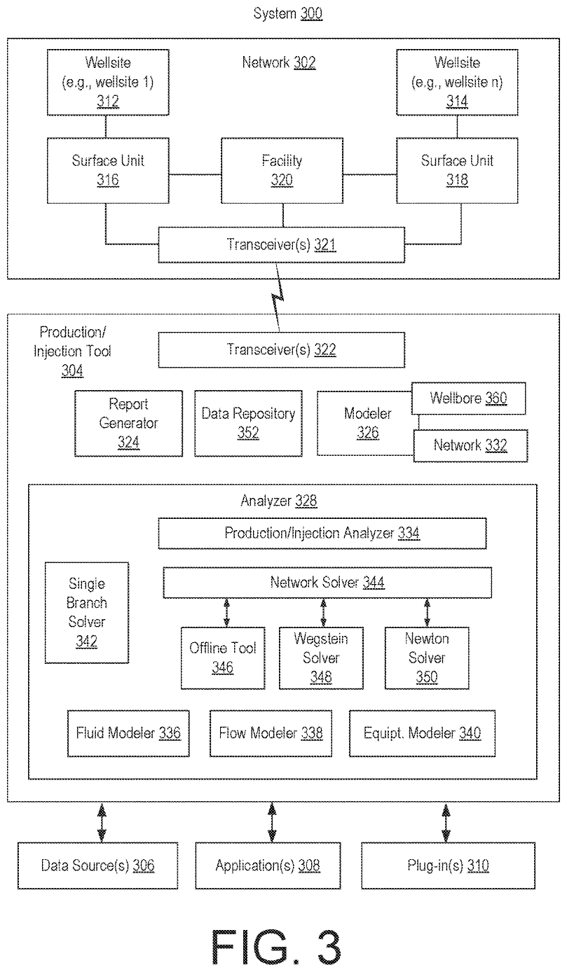

FIG. 3 shows an example of a schematic diagram of a system 300 for performing production and/or injection operations. As shown in the example of FIG. 3, the system 300 can include a network 302, a production and/or injection tool 304, one or more data sources 306, one or more application(s) 308, and one or more plug-in(s) 310. As an example, the network 302 can be an interconnection of pipes (e.g., conduits) that connects wellsites (e.g., a wellsite 1 312, a wellsite n 314, etc.) to a facility 320 (e.g., a production facility and/or a fluid supply facility for injection of fluid). A pipe in the network 302 may be connected to a facility (e.g., the facility 320), a wellsite (e.g., the wellsite 1 312, the wellsite n 314, etc.), and/or a junction in which pipes are connected. As an example, flow rate of fluid and/or gas into pipes may be adjustable; thus, certain pipes in the network 302 may be choked or closed so as to not allow fluid and/or gas through the pipe. In various instances, gas lift may be utilized as a form of artificial lift to facilitate production of fluid from a well; noting that one or more other techniques may be utilized, which may include use of one or more electric submersible pumps (ESPs) for assisting with production and/or injection. A pipe may be considered open (e.g., optionally choked) when the pipe allows for flow of fluid and/or gas. As to a choke, choking may allow for adjusting one or more characteristics of a piece of flow equipment (e.g., a cross-sectional flow area, etc.), for example, for adjusting to fully open flow, for adjusting to choked flow and/or for adjusting to no flow (e.g., closed).

The network 302 may be a gathering network and/or an injection network. A gathering network may be a network used to obtain hydrocarbons from a wellsite (e.g., the wellsite 1 312, the wellsite n 314, etc.). In a gathering network, hydrocarbons may flow from the wellsites to the processing facility 320. An injection network may be a network used to inject the wellsites with injection substances, such as water, carbon dioxide, and other chemicals that may be injected into the wellsites. In an injection network, the flow of the injection substance may flow towards the wellsite (e.g., toward the wellsite 1 312, the wellsite n 314, etc.).

The network 302 may also include one or more surface units (e.g., a surface unit 1 316, a surface unit n 318, etc.), for example, a surface unit for each wellsite. Such surface units may include functionality to collect data from sensors. Such sensors may include sensors for measuring flow rate, water cut, gas lift rate, pressure, and/or other such variables related to measuring and monitoring hydrocarbon production. As shown, the network 302 can include one or more transceivers 321, for example, to receive information, to transmit information, to receive information and transmit information, etc. As an example, information may be received and/or transmitted via wire and/or wirelessly. As an example, information may be received and/or transmitted via a communications network such as, for example, the Internet, the cloud, a cellular network, a satellite network, etc.

As an example, the production and/or injection tool 304 may be connected to the network 302. The production and/or injection tool 304 may be a simulator (e.g., a simulation framework) or a plug-in for a simulator (e.g., or other application(s)). The production and/or injection tool 304 may include one or more transceivers 322, a report generator 324, a modeler 326, and an analyzer 328. As an example, the one or more transceivers 322 may be configured to receive information, to transmit information, to receive information and transmit information, etc. As an example, information may be received and/or transmitted via wire and/or wirelessly. As an example, information may be received and/or transmitted via a communications network such as, for example, the Internet, the cloud, a cellular network, a satellite network, etc.

As an example, the report generator 324 can include functionality to produce graphical and textual reports. Such reports may show historical oilfield data, production models, production results, sensor data, aggregated oilfield data, or any other such type of data.

As an example, the data repository 352 may be a storage unit and/or device (e.g., a file system, database, collection of tables, or any other storage mechanism) for storing data, such as the production results, sensor data, aggregated oilfield data, or any other such type of data. As an example, the data repository 352 may include multiple different storage units and/or hardware devices. Such multiple different storage units and/or devices may or may not be of the same type or located at the same physical site. As an example, the data repository 352, or a portion thereof, may be secured via one or more security protocols, whether physical, algorithmic or a combination thereof (e.g., data encryption, secure device access, secure communication, etc.).

In the example of FIG. 3, the modeler 326 can include functionality to create a model of a wellbore and a network where the wellbore is in fluid communication with a reservoir. As shown, the modeler 326 includes a wellbore modeler 360 and a network modeler 332. As an example, the wellbore modeler 360 can allow a user to create a graphical wellbore model or single branch model. As an example, a wellbore model can define operating parameters (e.g., actual, theoretical, etc.) of a wellbore (e.g., pressure, flow rate, etc.). As an example, a single branch model may define operating parameters of a single branch in a network.

As to the network modeler 332, it may allow a user to create a graphical network model that combines wellbore models and/or single branch models. As an example, the network modeler 328 and/or wellbore modeler 360 may model pipes in the network 302 as branches of the network 302 (e.g., optionally as one or more segments, optionally with one or more nodes, etc.). In such an example, each branch may be connected to a wellsite or a junction. A junction may be defined as a group of two or more pipes that intersect at a particular location (e.g., a junction may be a node or a type of node).

As an example, a modeled network may be formed as a combination of sub-networks. In such an example, a sub-network may be defined as a portion of a network. For example, a sub-network may be connected to the network 302 using at least one branch. Sub-networks may be a group of connected wellsites, branches, and junctions. As an example, sub-networks may be disjoint (e.g., branches and wellsites in one sub-network may not exist in another sub-network).

As an example, the analyzer 328 can include functionality to analyze the network 302 and generate a result for the network 302. As shown in the example of FIG. 3, the analyzer 328 may include one or more of the following: an analyzer 334, a fluid modeler 336, a flow modeler 338, an equipment modeler 340, a single branch solver 342, a network solver 344, a Wegstein solver 348, a Newton solver 350, and an offline tool 346.

As an example, the analyzer 334 can include functionality to receive a workflow request and interact with the single branch solver 342 and/or the network solver 344 based on particular aspects of the workflow. For example, the workflow may include a nodal analysis to analyze a wellsite or junction of branches, pressure and temperature profile, model calibration, gas lift design, gas lift optimization, network analysis, and other such workflows.

As an example, the fluid modeler 336 can include functionality to calculate fluid properties (e.g., phases present, densities, viscosities, etc.) using one or more compositional and/or black-oil fluid models, which can involve using one or more EoSs. The fluid modeler 336 may include functionality to model oil, gas, water, hydrate, wax, asphaltene phases, etc. As an example, the flow modeler 338 can include functionality to calculate pressure drop in pipes (e.g., pipes, tubing, etc.) using industry standard multiphase flow correlations. As an example, the equipment modeler 340 can include functionality to calculate pressure changes in equipment pieces (e.g., chokes, pumps, compressors, etc.). As an example, one or more substances may be introduced via a network for purposes of managing asphaltenes, waxes, etc. As an example, a modeler may include functionality to model interaction between one or more substances and fluid (e.g., including material present in the fluid).

As an example, the single branch solver 342 may include functionality to calculate the flow and pressure drop in a wellbore or a single flowline branch given various inputs.

As an example, the network solver 344 can includes functionality calculate a flow rate and pressure drop throughout the network 302. The network solver 344 may be configured to connect to the offline tool 346, the Wegstein solver 348, and the Newton solver 350. As an example, alternatively or additionally, one or more other solvers may be provided, for example, consider a sequential linear programming solver (SLP), a sequential quadratic programming solver (SQP), etc. As an example, a solver may be part of the production and/or injection tool 304, part of the analyzer 328 of the production and/or injection tool 304, part of a system to which the production and/or injection tool 304 may be operatively coupled, etc.

As an example, the offline tool 346 may include a wells offline tool and a branches offline tool. A wells offline tool may include functionality to generate a model using the single branch solver 342 for a wellsite or branch. A branches offline tool may include functionality to generate a model for a sub-network using the model for a wellsite, a single branch, or a sub-network of the sub-network.

As an example, a model may be capable of providing a description of a wellsite with respect to various operational conditions. A model may include one or more functions that may be combined, for example, where each function may be a function of variables related to production of hydrocarbons. For example, a function may be a function of flow rate and/or pressure. Further, a function may account for environmental conditions related to a sub-network of the oilfield network 302, such as changes in elevation (e.g., for gravity head, pressure, etc.), diameters of pipes, combination of pipes, and changes in pressure resulting from joining pipes. A model may provide estimates of flow rate for a wellsite or sub-network of an oilfield network.

As an example, one or more separate functions may exist that can account for changes in one or more values of an operational condition. An operational condition may identify a property of hydrocarbons or injection substance. For example, an operational condition may include a watercut (WC), reservoir pressure, gas lift rate, etc. Other operational conditions, variables, environmental conditions may be considered.

As to the network solver 344, in the example of FIG. 3, it is shown as being connected to the Wegstein solver 348 and/or the Newton solver 350. The Wegstein solver 348 and the Newton solver 350 include functionality to combine a model for several sub-networks to create a result that may be used to plan a network, optimize flow rates of wellsites in a network, and/or identify and address faulty components within a network. The Wegstein solver 348 can use an iterative method with Wegstein acceleration.

One or more types of physical phenomena of a network may be solved by identifying pressure drop (e.g., pressure differential), for example, through use of momentum equations. As an example, an equation for pressure differential may account for factors such as fluid potential energy (e.g., hydrostatic pressure), friction (e.g., shear stress between conduit wall and fluid), and acceleration (e.g., change in fluid velocity). As an example, an equation may be expressed in terms of static reservoir pressure, a flowing bottomhole pressure and flowrate. As an example, equations may account for vertical, horizontal or angled arrangements of equipment. Various examples of equations may be found in a dynamic multiphase flow simulator such as the simulator of the OLGA simulation framework (SLB, Houston, TX), which may be implemented for design and diagnostic analysis of oil and gas production systems. As an example, a simulation framework may include one or more sets of instructions for building a model; for fluid and multiphase flow modeling; for reservoir, well and completion modeling; for field equipment modeling; and for operations (e.g., artificial lift, gas lift, wax prediction, nodal analysis, network analysis, field planning, multi-well analysis, etc.).

As an example, a system may implement equations that include dynamic conservation equations for momentum, mass and energy. As an example, pressure and momentum can be solved implicitly and simultaneously and, for example, conservation of mass and energy (e.g., temperature) may be solved in succeeding separate stages.

As an example, an equation for pressure differential can account for factors such as fluid potential energy (e.g., hydrostatic pressure), friction (e.g., shear stress between conduit wall and fluid), and acceleration (e.g., change in fluid velocity). In addition, as mentioned, equations can be used to take into account dynamic aspects. For example, equations can account for time and forces to accelerate and decelerate fluid (e.g., and objects) inserted into multiphase flow (e.g., consider pigs, etc.). As an example, an approach may consider the time it takes to conserve mass and energy (e.g., an amount of time it takes to drain a system, pipeline or vessel). As an example, an approach may consider ramp-up time for production, for example, from one production rate to another production rate, etc. As an example, an approach may consider time it takes before a first condensate appears at an outlet of a production network during startup, etc.

As an example, an equation for a pressure differential (e.g., ΔP) may be rearranged to solve for flow rate (e.g., Q), where the equation may include the Reynolds number (e.g., Re, a dimensionless ratio of inertial to viscous forces), one or more friction factors (e.g., which may depend on flow regime), etc.

Through use of equations for flow into and out of a branch and equating to zero, a linear matrix in unknown pressures may be obtained. As an example, fixed flow branches (i.e., branches in which the flow does not change) may be solved directly for the node pressures.

As an example, a method can include defining variables and residual equations as well as branches in a network that may include a number of equipment items. As an example, a branch may be divided into sub-branches with each sub-branch containing a single equipment item. As an example, a new node may be used to join each pair of sub-branches. In such an example, primary Newton-Raphson variables can include a flow (Qib) in each sub-branch in the network and a pressure Pin at each node in the network. In this example, temperature (or enthalpy) and composition may be treated as secondary variables.

As an example, residual equations may include a branch residual, an internal node residual, and a boundary condition. In such an example, a branch residual for a sub-branch relates the branch flow to the pressure at the branch inlet node and the pressure at the outlet node. As an example, internal node residuals can define where total flow into a node is equal to total flow out of the node.

As an example, determining an initial solution may be performed using a production model where for each subsequent iteration, a Jacobian matrix is calculated. The values of the Jacobian matrix may be used to solve a Jacobian equation for the Newton-Raphson update. To solve the Jacobian equation, one or more types of matrix solvers may be used. As an example, one or more types of preconditioners may be used, for example, as may be applied to one or more matrixes.

In the example of FIG. 3, the one or more data sources 306 include one or more types of repositories for data. For example, the one or more data sources 306 may be Internet sources, sources from a company having ties to the network 302, or any other location in which data may be obtained. The data may include historical data, data collected from other networks, data collected from the network being modeled, data describing environmental or operational conditions.

In the example of FIG. 3, the one or more applications 308 may be applications related to the production of hydrocarbons and/or injection of fluid. The one or more applications 308 may include functionality to evaluate a formation, manage drilling operations, evaluate seismic data, evaluate workflows in a field, perform simulations, or perform any other related function. In the example of FIG. 3, the one or more plug-ins 310 may allow integration with packages such as, for example, a TUFPP model, an Infochem Multiflash model (Infochem Computer Services Ltd., London, UK), an equipment model, etc. (e.g., consider one or more simulators like HYSYS (AspenTech, Burlington, Massachusetts), UNISIM (Honeywell, Morristown, New Jersey), etc.).

While the example of FIG. 3 shows the production and/or injection tool 304 as a separate component from the network 302, the production and/or injection tool 304 may alternatively be part of the network 302. For example, the production and/or injection tool 304 may be located at one of the wellsites (e.g., the wellsite 1 312, the wellsite n 314, etc.), at the facility 320, or any other location in the network 302. As another example, the production and/or injection tool 304 may exist separate from the network 302, such as when the production and/or injection tool 304 is used to plan the network.

Various types of numerical solution schemes involved in simulation may be characterized as being explicit or implicit. For example, when a direct computation of dependent variables can be made in terms of known quantities, a scheme may be characterized as explicit. Whereas, when dependent variables are defined by coupled sets of equations, and either a matrix or iterative technique is implemented to obtain a solution, a scheme may be characterized as implicit.

As an example, a scheme may be characterized as adaptive implicit (“AIM”). An AIM scheme may adapt, for example, based on one or more gradients as to one or more variables, properties, etc. of a model. For example, where a model of a subterranean environment includes a region where porosity varies rapidly with respect to one or more physical dimensions (e.g., x, y, or z), a solution for one or more variables in that region may be modeled using an implicit scheme while an overall solution for the model also includes an explicit scheme (e.g., for one or more other regions for the same one or more variables).

As an example, a scheme may be implemented as part of the ECLIPSE 300 reservoir simulator. As an example, the aforementioned OLGA simulator may include an interface that allows for interoperability with an ECLIPSE simulator. The ECLIPSE 300 reservoir simulator may implement a fully implicit scheme or an implicit-explicit scheme that is implicit in pressure and explicit in saturation, known as IMPES. In the fully implicit scheme, values for both pressure and saturation are provided at the end of each simulation time-step; whereas, the IMPES scheme uses saturation values from the beginning of the time-step to solve for pressure values at the end of the time-step. In such examples, a reservoir simulator iterates until pressures values in grid blocks of a model of the reservoir being simulated have reached some internally consistent solution. However, a solution may be difficult to find if saturation (which the IMPES scheme assumes is constant within a time-step) changes rapidly during that time-step (e.g., a large percentage change in grid block values for saturation). The IMPES scheme may be able to cope with such an issue by decreasing “length” (e.g., duration) of the time-step but at the cost of more time-steps (e.g., in an effort to achieve a more stable solution).

The aforementioned fully implicit scheme may be a more stable option with saturation and pressure being obtained simultaneously so as any difference between their values for one time-step and a next time-step does not disturb a solution process as much as when compared to the IMPES scheme. Thus, in a fully implicit scheme, the “length” (e.g., duration) of a time-step may be larger but it also means that the fully implicit scheme may take additional processing time to achieve solutions (e.g., in comparison with an IMPES scheme). However, in a reservoir where properties change rapidly, a fully implicit scheme may provide a solution in less computational time than an IMPES scheme, even though an iteration of the fully implicit scheme may take longer to complete when compared to an iteration of the IMPES scheme.

The aforementioned ECLIPSE 300 reservoir simulator may also implement one or more components such as a black-oil simulator component, a compositional simulator component, or a thermal simulator component (e.g., for simulating thermodynamics, etc.). As an example, a black-oil simulator component may include equations to model three fluid phases (e.g., oil, water, and gas, with gas dissolving in oil and oil vaporizing in gas); as an example, a compositional simulator component may include equations to model phase behavior and compositional changes; and, as an example, a thermal simulator component may include instructions (e.g., for equations, etc.) to model a thermal recovery processes such as steam-assisted gravity drainage (SAGD), cyclic stream operations, in-situ combustion, heater, and cold heavy oil production with sand. As an example, one or more thermal components may provide instructions for modeling and simulating multiple hydrocarbon components in both oil and gas phases, a single nonvolatile component in an oil phase, oil, gas, water, and solids behaviors (e.g., optionally with chemical reactions), well production rates based on factors such as well temperature, low-temperature thermal scenarios (e.g., experiments or cold heavy oil production with sand), toe-to-heel air injection scenarios, foamy oil (e.g., as to effect on gas production, gas drive, oil production, etc.), multi-segmented well models (e.g., optionally including dual-tubing, horizontal wells, multiphase flow effects in a wellbore, etc.).

As to network models, as an example, a method can include simulation of dynamic and/or steady state operation of an oil and gas production system over various ranges of operating conditions and configurations. In such an example, the method may include an implicit evaluation of conservation of energy equations in addition to mass and momentum as an effective technique for efficiently and robustly simulating the production system where, for example, the production system includes fluid such as heavy oil, steam or other fluids at or near critical pressures or temperatures. The term “critical point” may be used herein to specifically denote a vapor-liquid critical point of a material, above which distinct liquid and gas phases do not exist. For example, above the critical point, a fluid may exist as a supercritical fluid; noting that a supercritical fluid may exist below the pressure required to compress a fluid into a solid. A supercritical fluid may exhibit particular properties, behaviors, etc. For example, a supercritical fluid may effuse through porous solids like a gas, overcoming mass transfer limitations that slow liquid transport through such materials. A supercritical fluid may be superior to a gas in its ability to dissolve materials like liquids and/or solids. For example, supercritical CO2 finds use in decaffeination of coffee where a co-solvent (e.g., water or ethanol) may be employed to increase caffeine solubility in supercritical CO2 (e.g., to accelerate extraction of caffeine). In various instances, near the critical point, relatively small changes in pressure and/or temperature may result in relatively large changes in density.

As mentioned, a system can provide for transportation of oil and gas fluids from well locations along flowlines which are interconnected at junctions to combine fluids from many wells for delivery to a processing facility and/or to provide for delivery of fluid to one or more wells. Along flowlines (e.g., including at one or more ends of a flowline), equipment may be inserted to modify the flowing characteristics like flow rate, pressure, composition and temperature. As an example, a boundary condition may depend on a type of equipment, operation of a piece of equipment, etc.

As an example, a simulation may be performed using one type of equipment along a flowline and another simulation may be performed using another type of equipment along the same flowline, for example, to determine which type of equipment may be selected for installation in a system.

As an example, a simulation may be performed using one type of equipment at a position (e.g., with respect to a flowline) and another simulation may be performed using another type of equipment at a different position (e.g., with respect to the same flowline or a different flowline), for example, to determine which type of equipment may be selected for installation in a system as well as to determine where a type of equipment may be installed. As an example, a simulation may be performed using one type of equipment at a position (e.g., with respect to a flowline) and another simulation may be performed using that type of equipment at a different position (e.g., with respect to the same flowline or a different flowline), for example, to determine where that type of equipment may be installed.

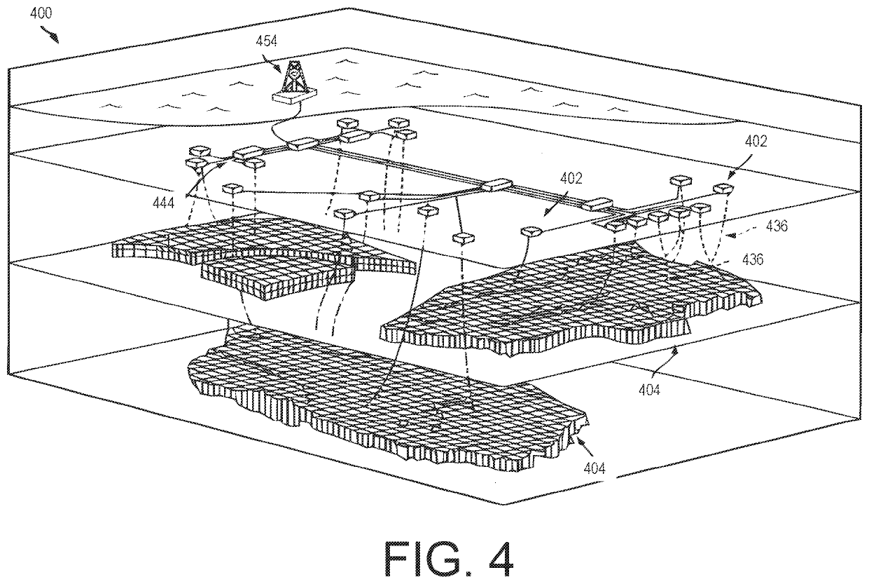

FIG. 4 shows an example of a geologic environment 400 and a system of various types of equipment. As shown, the geologic environment 400 includes a plurality of wellsites 402 operatively connected to a facility 454. In the example of FIG. 4, individual wellsites 402 can include equipment that can form individual wellbores 436. Such wellbores can extend through subterranean formations 406 including one or more reservoirs 404. Such reservoirs 404 may include fluids, such as hydrocarbons, water, etc. As an example, wellsites may draw fluid from one or more reservoirs and pass them to one or more facilities via one or more surface networks 444. As an example, a surface network can include tubing and control mechanisms for controlling flow of fluids from a wellsite to a processing facility. As explained, a surface network may include equipment for delivery of fluid to a wellsite or wellsites.

As an example, a method can include executing a computational framework that includes at least one processor for determining composition properties of one or more types of fluids. For example, consider a framework that includes the PVTz analysis software (SLB, Houston, Texas). Such a framework can process laboratory measured PVT data for fluids. For example, such a framework can record fluid phase behavior during PVT lab analyses. As an example, such a framework can be operatively coupled to lab equipment to use position and other types of data (e.g., piston position to compute volumes). Such a framework can perform material balance calculations, equilibrium checks, oil-based mud contamination assessments, etc. As an example, such a framework can perform flash calculations. Such a framework may implement one or more different equations of state (EoSs). As an example, an ECLIPSE simulator compositional simulation E300 flash package may be utilized (e.g., PVTToolbox) to compute densities at various downhole conditions for various fluid types, for example, using the 3-parameter Peng Robinson adjusted EoS or, for example, one or more other EoSs. The Peng Robinson EOS is a cubic EoS for thermodynamic modelling of pressure as a function of temperature and density. For example, a cubic EOS can provide a cubic function of molar volume Vₘ.

As to the Peng Robinson EoS, it aims to provide a framework where parameters can be expressible in terms of critical properties and the acentric factor; the model can provide reasonable accuracy near the critical point, particularly for calculations of the compressibility factor and liquid density; mixing rules can be formulated to not employ more than a single binary interaction parameter, which can be independent of temperature, pressure and composition; and the equation can be applicable to calculations of fluid properties in natural gas processes.

The Peng Robinson EoS may be represented as follows:

$$p = \frac{RT}{{V}_{m} - b} - \frac{a α}{{V}_{m}^{2} + 2 {bV}_{m} - {b}^{2}}$$

$$a \approx 0.45724 \frac{{R}^{2} {T}_{c}^{2}}{{p}_{c}}$$

$$b \approx 0.0778 \frac{{RT}_{c}}{{p}_{c}}$$

$$α = {( 1 + κ ( 1 - {T}_{r}^{0.5} ) )}^{2}$$

$$κ \approx 0.37464 + 1.5226 ω - 0.26992 {ω}^{2}$$

$${T}_{r} = T / {T}_{c}$$

Above, Vₘ is molar volume and the subscript “c” represents critical, and, in polynomial form as function of the compressibility factor Z, the Peng Robinson EoS may be presented as follows:

$$A = \frac{α ap}{{R}^{2} {T}^{2}}$$

$$B = \frac{bp}{RT}$$

$${Z}^{3} - ( 1 - B ) {Z}^{2} + ( A - 2 B - 3 {B}^{2} ) Z - ( AB - {B}^{2} - {B}^{3} ) = 0$$

$$Z = \frac{PV}{nRT}$$

As to some other examples, a method or system may utilize the Redlich Kwong EoS, the Soave modification of the Redlich Kwong (SRK) EOS, the SRK with volume translation of Peneloux (SRK-P), or another EoS formulation. As to the Soave modification of the Redlich Kwong (SRK) EoS, consider the following equations:

$$p = \frac{RT}{{V}_{m} - b} -$$

$$a \approx 0.42747 \frac{{R}^{2} {T}_{c}^{2}}{{P}_{c}}$$

$$b \approx 0.08664 \frac{{RT}_{c}}{{P}_{c}}$$

$$α = {( 1 + κ ( 1 - {T}_{r}^{0.5} ) )}^{2}$$

$$κ \approx 0.48508 + 1.55171 ω - 0.15613 {ω}^{2}$$

$${T}_{r} = T / {T}_{c}$$

As to the SRK, consider a short-hand representation as follows:

$$p = \frac{RT}{{V}_{m , SRK} - b} -$$

$$a = {a}_{c} α$$

$${a}_{c} \approx 0.42747 \frac{{R}^{2} {T}_{c}^{2}}{{P}_{c}}$$

$$b \approx 0.08664 \frac{{RT}_{c}}{{P}_{c}}$$

As to SRK-P, a factor “c” is introduced, which is a parameter of individual fluid components that can be estimated by a correlation that includes a Rackett compressibility factor (ZRA). For example, consider:

$${c}_{i} \approx 0.40768 \frac{{RT}_{ci}}{{P}_{ci}} ( 0.29441 - 0.29056 - 0.08775 {ω}_{i} )$$

In SRK-P, c can be summed for a number of components and it can be utilized to replace or supplement the factor “b” of SRK (e.g., b replaced by c, a sum of b and c or b minus c).

As to PVT analyses, it can provide output as to how fluids behave within a reservoir, within the wells, at surface conditions, in a conduit network, at a refinery, etc. A method can call for various fluid properties to be estimated or known over a range of temperatures and/or a range of pressures. As an example, when gas is injected into a reservoir, a method can include determining how properties of the original reservoir fluid will change as the composition changes.

PVT analyses as to fluid properties can help with predictions as to one or more of the following: the composition of a well stream as a function of time; completion design, which depends on the properties of the wellbore; liquids; whether to inject or re-inject gas, and if so, the detailed specification of the injected gas; how much C3, C4, C5's to leave in; separator configuration and stage for injection gas; miscibility effects that may result from the injected gas; amounts and composition of liquids left behind and their properties: density, surface tension, viscosity, etc.; separator/NGL plant specifications; H₂S and N₂ concentration in produced gas; product values versus time; etc.

As to compositional simulation (or composition simulation) using a simulator, it can provide output that is improved with respect to black-oil simulation. Composition simulation output can provide improved description of reservoir processes in a number of situations. For example, compositional simulation can assist in EOR processes that involve a miscible displacement; cases where gas injection/re-injection into an oil produces large compositional changes in the fluids; if condensates are recovered using gas cycling (injected gas is substantially different from the composition of free gas in the reservoir); surface facilities detailed compositions of one or more production streams; times and timings; oil production rate(s); etc. Composition simulation can provide insight as to phase behavior; multi-contact miscibility; immiscible or near-miscible displacement behavior in compositionally dependent mechanisms such as vaporization, condensation, and oil swelling; composition-dependent phase properties such as viscosity and density on miscible sweep-out; and interfacial tension (IFT) especially the effect of IFT on residual oil saturation. Such effects can have a substantial effect on production of one or more resources from a reservoir or reservoirs.

In a black-oil approach, a fluid may be fully described by fluid properties in a table of property versus pressure; whereas, in a compositional approach, a solver can be utilized to solve a flash equation and solve an EoS.

With the presence of fluid data from multiple sources (e.g., fluid sampling, production testing, etc.), building one or more EoSs that can comprehensively characterize hydrocarbon fluid at different levels of a production system while honoring measured data may be performed. As an example, one or more machine learning approaches may be implemented which may provide for data-driven and/or physics-based model-driven approaches.

As explained, a subsurface CO2 operations framework can be utilized for Carbon Capture and Storage (CCS) operations (e.g., or CCUS operations), which can include modeling that can involve computing fluid acoustic properties that consider complex changes in fluid composition resulting from CO2 injection. As mentioned, such a framework can integrate thermodynamically driven fluid acoustic properties into one or more workflows, which can include Sim2Seis workflows.

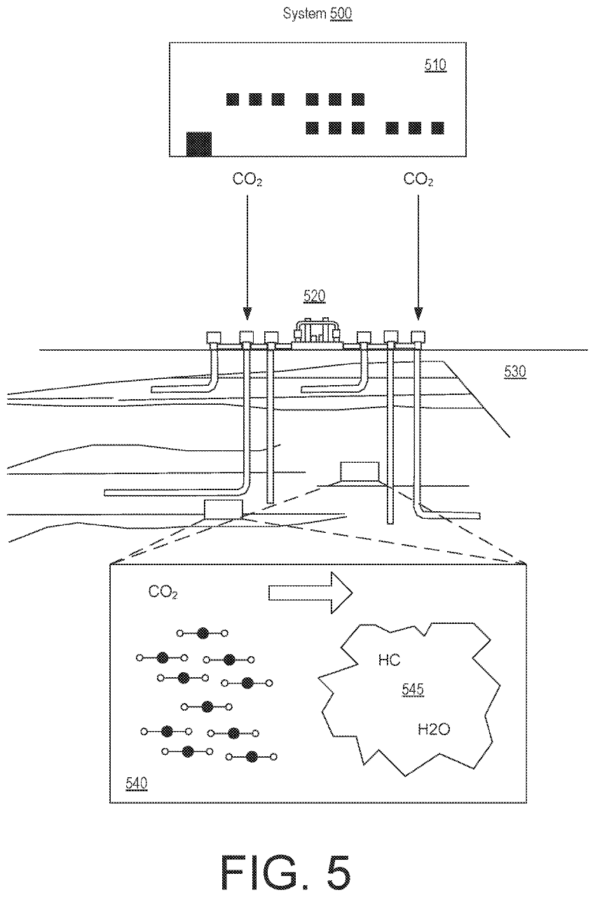

FIG. 5 shows an example of a system 500 that includes a facility 510 that generates CO2 and a surface network 520 with wells that extend into one or more subsurface regions 530 where the CO2 generated by the facility 510 can be injected into at least one of the one or more subsurface regions 530 to store the CO2. As shown in a graphic 540, CO2 can enter rock 545, which can include hydrocarbons (HC) and/or water (H₂O or H₂O). In such an example, mixing may occur such that the rock 545 becomes saturated with fluid that includes CO2 and, for example, one or more other components (e.g., HC and/or H₂O).

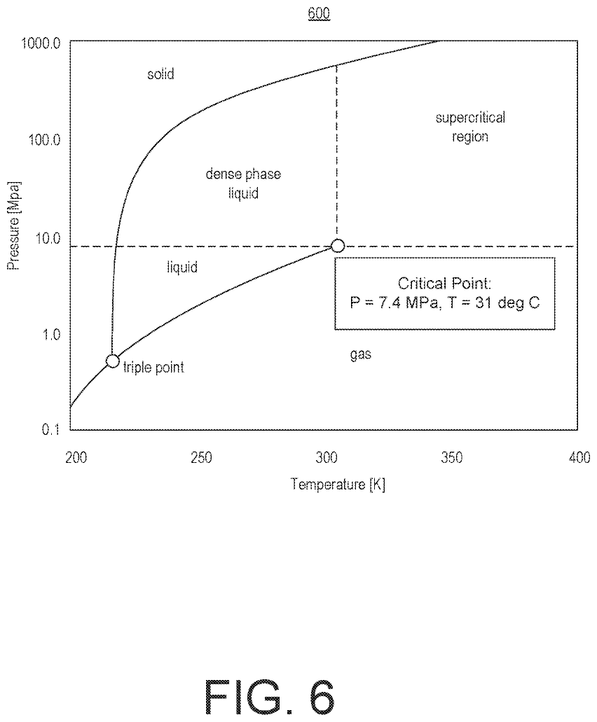

FIG. 6 shows an example of a pressure and temperature phase diagram for CO2. As shown, regions can include gas, liquid, solid, dense phase liquid, and a supercritical region that extends to pressures and temperatures above the critical point, which can be approximately at a pressure of 7.4 MPa and a temperature of 31 degrees Celsius.

CO2 usually behaves as a gas in air at standard temperature and pressure (STP), or as a solid called dry ice when cooled and/or pressurized sufficiently. If the temperature and pressure are both increased from STP to be at or above the critical point for CO2, it can adopt properties between a gas and a liquid. More specifically, CO2 can behave as a supercritical fluid above its critical temperature (e.g., 31 degrees Celsius) and critical pressure (e.g., 7.4 MPa or 74 bar). Supercritical CO2 can expand to fill its “container” like a gas but with a density like that of a liquid. Thus, supercritical CO2 can behave quite different than subcritical CO2. And, where CO2 mixes with one or more other components, its behavior (e.g., as exhibited by physical properties) can be challenging to predict.

As an example, phase behavior of CO2 may be modeled using one or more EoSs. As an example, CO2 as a fluid may be modeled alone or in a mixture. For example, consider CO2 and water as a mixture. In various examples, once CO2 is modeled or characterized, whether alone or as a mixture, it may optionally be combined with one or more additional components to form a final mixture that is suitable for use in one or more workflows. In such an approach, one or more mixing models and/or rules may be employed. As an example, multiple techniques may be employed where an ensemble approach can involve taking one or more types of averages (e.g., arithmetic, harmonic, etc.) to arrive at acceptable values.

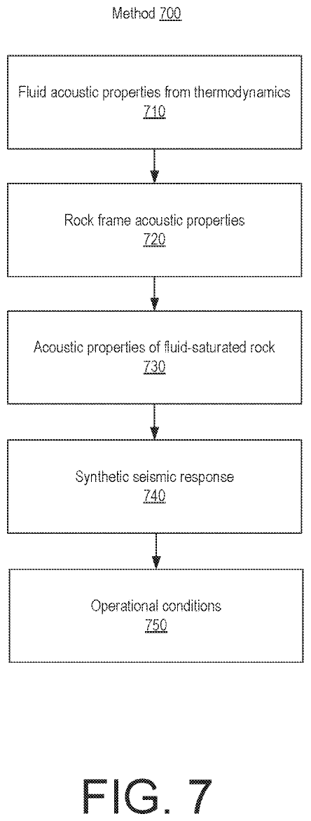

FIG. 7 shows an example of a workflow 700 that can include a determination block 710 for determining fluid acoustic properties using thermodynamics, a determination block 720 for determining rock frame acoustic properties, a determination block 730 for determining acoustic properties of fluid saturated rock, and a generation block 740 for generating a synthetic seismic response using at least the acoustic properties of the fluid saturated rock where the fluid saturated rock includes CO2, which may be in a subcritical state and/or supercritical state. The workflow 700 of FIG. 7 can provide for accurate estimation of fluid mixture properties that can enhance a Sim2Seis workflow within the field of seismic modeling in CCS applications.

As explained, various CO2 injection techniques in CCS operations can induce changes in fluid composition within a reservoir. Often, pressure and temperature conditions are designed to place the injected CO2 in the supercritical state, which possesses relatively unique physical properties combining characteristics of gas and liquid. On the other hand, when CO2 is injected into depleted hydrocarbon reservoirs, it can mix with residual oil and/or gas. In both scenarios, conventional equations like those of Batzle and Wang (1992) tend to fail to accurately compute fluid acoustic parameters. The workflow 700 of FIG. 7 can improve determinations as to acoustic parameters (e.g., acoustic velocity, etc.).

As an example, the workflow 700 can utilize fluid thermodynamics and an EoS that may be calibrated with experimental laboratory data and/or flash computations to more accurately compute fluid mixture isothermal compressibility. Additionally, the heat capacity ratio can be computed from thermodynamics to convert the isothermal compressibility to adiabatic compressibility. Adiabatic compressibility is a type of compressibility that a seismic wave will experience and hence sense. Thus, adiabatic compressibility can be used in rock physics modeling for one or more purposes, which can include synthetic seismic generation. Another parameter that finds use in seismic workflows is bulk modulus, where, for an adiabatic process in an ideal gas, the bulk modulus may be given as B=−V (dP/dV)=γP, where γ=C_{P}/C_{V}. Bulk modulus of a fluid, gas or solid may characterize resistance to change of such a material when a uniform pressure is applied; noting that bulk modulus may be described with respect to acoustic velocities of P- and S-waves, for example, consider B=ρ(V_{P}²−(4/3) V_{S}²).

As to rock physics modeling, it can include velocity modeling such as constructing a velocity model of a subsurface region where seismic energy (e.g., acoustic energy) may travel, reflect, etc. A seismic survey can emit and sense seismic energy, which can be stored as digital seismic data. One or more types of workflows can be performed such as forward modeling and/or inversion using seismic data, for example, to refine a velocity model, to identify subsurface structures, to understand how subsurface structures and/or fluids may change with respect to time (e.g., consider 4D seismic), etc.

As mentioned, a flash computation may be performed, which can utilize a so-called flash package (e.g., consider one or more of the Infochem flash packages such as a Multiflash package). Multiflash is a comprehensive PVT and physical properties package that allows for modeling and solving phase behavior of complex mixtures and pure substances. Multiflash is designed to model various coexisting phases and mixtures. Multiflash includes various tools, models, and EoSs.

As an example, a framework can implement flash computations where output can include isothermal compressibility. As the heat capacity ratio can be known, the speed of sound can be computed. As to isothermal and adiabatic, in an adiabatic process, there is no transfer of heat towards or from a fluid; whereas, in an isothermal process, there is a transfer of heat to the surroundings to make the overall temperature constant.

As an example, isothermal compressibility, KT can be defined as:

$${K}_{T} = - ( 1 / V ) {( \partial V / \partial P )}_{T}$$

In the 1700s, Newton computed the speed of sound through air, assuming that sound was carried by isothermal compression waves. The computed value of 949 m/s was about 15 percent smaller than experimental determinations. Newton accounted for the difference by pointing to non-ideal effects. However, in actuality, compression waves are adiabatic, rather than isothermal. As such, small temperature oscillations can occur due to adiabatic compression followed by expansion of the fluid carrying the sound waves. Corrections were made by Laplace in the 1700s and 1800s. Laplace modeled the compression waves using the adiabatic compressibility, κ_{S}, which can be defined as:

$${K}_{S} = - ( 1 / V ) {( \partial V / \partial P )}_{S}$$

As entropy can be defined by dS=dqᵣₑᵥ/T, it follows that an adiabatic pathway (dq=0) is also isentropic (dS=0), or proceeds at constant entropy.

As an example, the speed of sound in a fluid can be defined as follows:

$$Speed of Sound = \sqrt{{( \frac{dP}{d ρ} )}_{S . Bulk}} = \sqrt{\frac{{C}_{P . Bulk}}{{C}_{V . Bulk}} ( \frac{{V}_{Bulk}^{2}}{{MW}_{Bulk}} ) {( \frac{dP}{dV} )}_{T . Bulk}}$$

where T is temperature, P is pressure, V is volume, C_{P}/C_{V} is the heat capacity ratio, and MW is molecular weight.

In thermal physics and thermodynamics, the heat capacity ratio, also known as the adiabatic index, the ratio of specific heats, or Laplace's coefficient, is the ratio of the heat capacity at constant pressure (C_{P}) to heat capacity at constant volume (C_{V}). It is sometimes also known as the isentropic expansion factor and is denoted by γ (gamma) for an ideal gas or κ (kappa), the isentropic exponent for a real gas.

As an example, a framework can provide for considering complexities of supercritical CO2 and CO2 mixing with residual oil and/or gas to overcome various limitations of the Batzle and Wang (1992) approach.

As an example, a framework can provide for integrating thermodynamically driven fluid acoustic properties within a Sim2Seis workflow. Such a framework can provide a viable solution that empowers CCS practitioners to incorporate accurate fluid acoustic properties, thereby enhancing effectiveness of simulation and seismic modeling in CCS operations.

As explained, a subsurface CO2 operational framework can help to improve understanding of fluid behavior and facilitate informed decision-making in carbon storage operations. Such a framework can accurately characterize fluid acoustic properties to advance optimization of CCS strategies, which can support management of greenhouse gas emissions in an efficient and sustainable manner.

As an example, a simulation may aim to simulate various physical phenomena to understand when and/or how a change in position of contact may occur (e.g., between two phases, types of fluids, etc.). In such an example, equipment may be controlled in a manner that can more favorably produce a desired resource from a reservoir or reservoirs.

As an example, fluid types may include, for example, from light to heavy: dry gas, wet gas, gas condensate, volatile oil, black-oil, heavy oil, super heavy oil, and asphaltene (e.g., DG, WG, CG, VO, BO, HO, SHO, ASP, respectively). In such example fluid types, each type may include a composition of components where at least some of the components may be characterized based on how many carbon atoms are in each component (e.g., from light carbon components such as methane (CH4) to heavier long chain and/or aromatic carbon components). Whether a component is in a liquid state or gas state can depend on various conditions, including pressure and temperature.

As an example, a framework can include features for combining thermodynamics and machine learning (ML) to predict compositional variation versus depth and/or segregate, as feasible, compositional variation associated to depth, which can be, for example, associated with compartmentalization. Such an approach can contribute to a more consistent and efficient initialization in a reservoir model that honors thermodynamics and addresses the uncertainty in reservoir fluid (PVT) data.

As an example, a method can involve selecting one or more of multiple EoS models and/or initial reservoir conditions for a specific field/reservoir with available PVT data covering a suitable range of variation in areal or vertical composition. Such a method may result in a set of initialization scenarios that can be directly used in dynamic simulation and capable of uncertainty assessment with regard to volumes initially in-place and production forecasting. As an example, initialization values for initialization of a reservoir model may be suitable for use in one or more simulation frameworks (e.g., ECLIPSE, INTERSECT, PIPESIME, OLGA, etc.).

As explained, one or more frameworks can provide for simulation of physical phenomena. For reservoir simulation, a simulator can be loaded with selections as to one or more EoSs and initial conditions. For example, consider a framework such as the PETREL framework as including features for automated EoS selection and initialization (e.g., setting of initial conditions, etc.) of one or more reservoir models, one or more surface networks, etc., suitable for use in one or more reservoir simulation frameworks, one or more surface network simulation frameworks, etc. In such an example, the framework may utilize an automated approach, which may supplement or supplant existing PVT modeling applications such as, for example, the PVTi application (SLB, Houston, Texas), the FLUIDMODELER application (SLB, Houston, Texas), etc.

The PVTi application provides for estimation of fluid properties and exporting PVT tables (e.g., suitable for the ECLIPSE simulator). As explained, a model can utilize a grid that adheres to geometry (e.g., from seismic surveys, etc.) along with property data to form a geocellular model, which can be initialized using a PVT model (e.g., PVT information to populate cells parameters of the geocellular model). Such a model can then be received by a reservoir simulator to generate simulation results, which may be compared against production history and/or well test data (e.g., history matching, etc.). PVT tables can include properties of reservoir rocks and fluids as a function of fluid pressure. Specifically, the PVTi application includes a compositional PVT EoS for characterizing a set of fluid samples for generation of PVT tables where the fluid samples aim to provide a more realistic starting point for reservoir simulation. As explained, an EoS can relate pressure to volume and temperature (e.g., PVT EoS). The PVTi application can be utilized to match an EoS to an observation (e.g., one or more fluid samples), for example, to create black oil PVT tables for a black oil model or compositional PVT parameters for a compositional model. In various instances, phase plots may be utilized, for example, consider a pressure versus temperature phase plot for one or more samples, etc. As an example, finger plots, ternary plots, etc. may be utilized. Various phase plots can include information as to bubble point pressure, dew point pressure, critical point (e.g., critical temperature and/or pressure), etc.

Approaches that utilize particular applications can involve manual interactions. For example, the PVTi application can provide for manual interactions between a user and a computing system for viewing phase plots, EoS-based simulations, making comparisons between EoS simulations and sample data. A fluid model can be manually edited, for example, to select an EoS, components, binary interaction coefficients, volume shifts, thermal properties viscosity coefficients, etc. As to EoS selection, PVTi can include the 2 parameter Peng Robinson (PR) EOS, the 2 parameter Soave Redlich Kwong (SRK) EoS, the Redlich Kwong (RK) EoS, the Zudkevitch Joffe (ZJ) EoS, the 3 parameter Peng Robinson (PR) EoS, the 3 parameter Soave Redlich Kwong (SRK) EoS, the Schmidt Wenzel (SW) EoS, etc., along with various viscosity correlation types (e.g., Lohrenz Bray Clark, Pedersen, Aasberg Peterson, etc.). An application such as the PVTi application can include performing regression on EOS parameters, for example, where a fluid description is incomplete, issues exist for an EoS, etc., where various regression variables may be selected manually. As an example, regression may be utilized to fit an EoS using a fluid model.

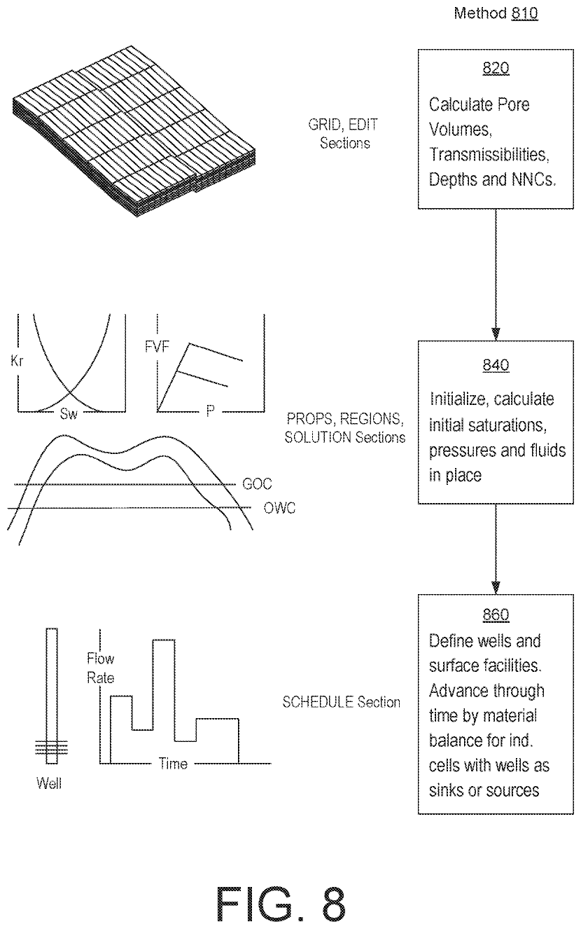

FIG. 8 shows an example of a method 810 that includes a calculation block 820 for calculating pore volumes, transmissibilities, depths and non-neighbor connections (NNCs), an initialization and calculation block 840 for initializing and calculating initial saturations, pressure and fluids in place (e.g., reserves, etc.), and a definition and time progression block 860 for defining one or more wells and surface facilities and advancing through time, for example, via material balances for individual cells (e.g., with the one or more wells as individual sinks and/or sources).

As to the initialization and calculation block 840, for an initial time (e.g., to), saturation distribution within a grid model of a geologic environment and pressure distribution within the grid model of the geologic environment may be set to represent an equilibrium state (e.g., a static state or “no-flow” state), for example, with respect to gravity. In the example of FIG. 8, various example plots are shown such as, for example, a spatial plot of gas-oil contact (GOC) and oil-water contact (OWC).

As mentioned, a reservoir simulator may advance in time. As an example, a numeric solver may be implemented that can generate a solution for individual time increments (e.g., points in time). As an example, a solver may implement an implicit solution scheme and/or an explicit solution scheme, noting that an implicit solution scheme may allow for larger time increments than an explicit scheme. Times at which a solution is desired may be set forth in a “schedule”. For example, a schedule may include smaller time increments for an earlier period of time followed by larger time increments.

A solver may implement one or more techniques to help assure stability, convergence, accuracy, etc. For example, when advancing a solution in time, a solver may implement sub-increments of time, however, an increase in the number of time increments can increase computation time. As an example, an adjustable increment size may be used, for example, based on information of one or more previous increments.

As an example, a numeric solver may implement one or more of a finite difference approach, a finite element approach, a finite volume approach, a point-based approach, etc. As an example, the ECLIPSE reservoir simulator can implement central differences for spatial approximation and forward differences in time. As an example, a matrix that represents grid cells and associated equations may be sparse, diagonally banded and blocked as well as include off-diagonal entries.

As an example, a solver may implement an implicit pressure, explicit saturation (IMPES) scheme. Such a scheme may be considered to be an intermediate form of explicit and implicit techniques. In an IMPES scheme, saturations are updated explicitly while pressure is solved implicitly.

As to conservation of mass, saturation values (e.g., for water, gas and oil) in individual cells of a grid cell model may be specified to sum to unity, which may be considered a control criterion for mass conservation. In such an example, where the sum of saturations is not sufficiently close to unity, a process may be iterated until convergence is deemed satisfactory (e.g., according to one or more convergence criteria). As governing equations tend to be non-linear (e.g., compositional, black oil, etc.), a Newton-Raphson type of technique may be implemented, which includes determining derivatives, iterations, etc. For example, a solution may be found by iterating according to the Newton-Raphson scheme where such iterations may be referred to as non-linear iterations, Newton iterations or outer iterations. Where one or more error criteria are fulfilled, the solution procedure has converged, and a converged solution has been found. Thus, within a Newton iteration, a linear problem is solved by performing a number of linear iterations, which may be referred to as inner iterations.

As an example, a solution scheme may be represented by the following pseudo-algorithm:

```
// Pseudo-algorithm for Newton-Raphson for systems
initialize(v);
do {
  //Non-linear iterations
  formulate_non_linear_system(v);
  make_total_differential(v);
  do {
    // Linear iterations:
    update_linear_system_variables(v);
  }
  while((linear_system_has_not_converged(v));
  update_non_linear_system_after_linear_convergence(v);
}
while((non_linear_system_has_not_converged(v))
```

As an example, a solver may perform a number of inner iterations (e.g., linear) and a number of outer iterations (e.g., non-linear). As an example, a number of inner iterations may be of the order of about 10 to about 20 within an outer iteration while a number of outer iterations may be about ten or less for an individual time increment.

As mentioned, fluid saturation values can indicate how fluids may be distributed spatially in a grid model of a reservoir. For example, a simulation may be run that computes values for fluid saturation parameters (e.g., at least some of which are “unknown” parameters) as well as values for one or more other parameters (e.g., pressure, etc.).

As to history matching, as explained, results of a simulation can be compared to actual field measurements. For example, fluid production rates from one or more wells may be measured and compared to fluid production rates generated by a simulator. In such an example, a simulation model can be adjusted until the simulated and actual fluid production rates match, according to one or more criteria.

Another process known as sensitivity analysis can involve generating many realizations of a reservoir model where each realization includes different parameter values. In such an example, a number of the realizations may be executed using a simulator to understand how simulation results relate to the variations in the parameter values (e.g., how sensitive the simulation results are to particular parameters and their values).

While a phase diagram is shown in FIG. 6 as to CO2, phase diagrams can be utilized for various aspects of modeling, operations, etc. For example, phase behavior for a reservoir suitable for CO2 injection and storage may be relevant whether the reservoir is currently partially depleted, or fully depleted or hydrocarbons and/or water. As an example, a workflow may include assessing one or more existing reservoirs that are producing hydrocarbons to determine when and how CO2 injection may occur.

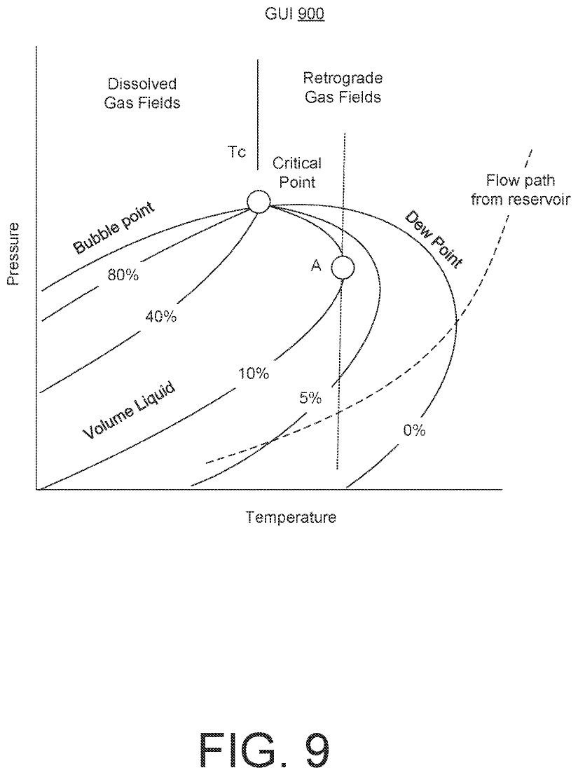

FIG. 9 shows an example of a graphical user interface 900 that includes a phase plot (e.g., a phase diagram) with respect to pressure and temperature. As shown, various types of fields may be characterized using such a phase plot (e.g., dissolved gas, retrograde, etc.). As shown, a flow path from a reservoir may be plotted on such a phase plot that can represent a wellbore where fluid is transported from a reservoir at a particular pressure and temperature to surface, which can be at a lesser pressure and temperature. As an example, such a plot can be generated from one or more samples (e.g., sample information) and/or using one or more EoSs.

As explained, a framework can include features for phase behavior analysis. Various types of phase behavior can be illustrated via a phase plot such as the phase plot of FIG. 9 (e.g., or FIG. 6). For example, a gas condensate field may produce mostly gas, with some liquid dropout, frequently occurring in a separator. As shown in FIG. 9, a retrograde gas field demands a temperature higher than the critical point temperature; noting that the vertical line on the phase plot shows the phase changes in a reservoir, while a dashed curve shows these changes as the fluid cools going up the wellbore and, for example, into a separator. In such instances, liquids can drop out as the pressure drops below dew point pressure.

With the retrograde condensate, the percent of liquid begins to increase to point “A” and then decreases with further pressure declines (“retrograde” meaning to retreat or go back). As shown, first condensation and then vaporization occurs, where such vaporization can help in further recovery of liquids.

In the example of FIG. 9, hydrocarbons above the dew point line are 100 percent gas and above the bubble point line are 100 percent liquid. Hydrocarbons above the bubble point line and close to the critical point tend to be volatile oils. The cricondentherm is the maximum temperature which two phase flow can exist (maximum temperature on the dew point line of the phase diagram); noting that a field may have both an oil leg and gas cap, which during depletion may produce some condensate from the gas.

Fields with active water drive may experience little pressure declines, so condensation occurs generally at the surface and a constant gas liquid ratio (GLR) may be expected.

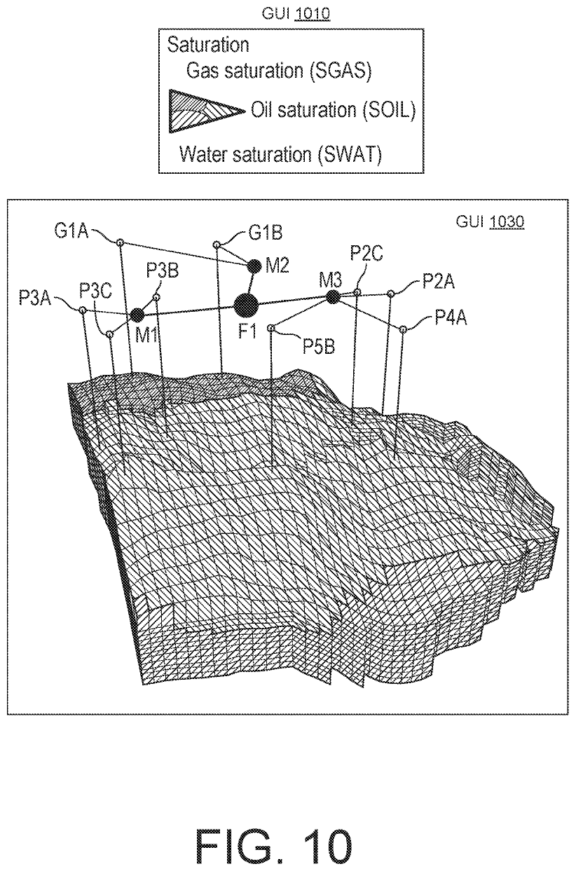

FIG. 10 shows examples of graphical user interfaces 1010 and 1030, which can show values as to saturation for gas, oil, water, and/or CO2 in a model of a system that includes a reservoir, a plurality of wells and various surface locations where fluids can mix (M1, M2 and M3) and eventually be transported to a facility (F1) and/or be injected for storage (e.g., consider CO2 injection). As an example, output from a simulator such as described with respect to FIG. 8, may be utilized to generate one or more GUIs such as, for example, the GUls 1010 and 1030. In the example of FIG. 10, the GUI 1030 may illustrate an original state (e.g., initial condition) or a later state, for example, a later state as based on simulation results. In the example GUI 1030, cells of a grid cell model that at least in part represents a reservoir can be assigned initial conditions, which can include compositional variation with respect to depth initial conditions.

In the example GUI 1030, the grid cell model shows grid cells as having different saturations; noting that the grid cell model can represent a reservoir that may be compartmentalized. As shown, the wells P3A-C may be in a particular region where fluid flows to the mixing location M1, the wells P2A, P2C and P4A-B may be in another region where fluid flows to the mixing location M3, and the wells G1A and G1B may be in yet another region where fluid flows to the mixing location M2. As shown, the wells G1A and G1B may be in regions of the reservoir that are gas saturated while various other wells are in oil saturated regions. As such, at the facility F1, various types of fluids can be collected where the fluids can be mixed. As an example, the facility F1 may be a CO2 injection facility that can inject CO2 into one or more compartments. As explained, a system may be handled using one or more frameworks. For example, consider using the ECLIPSE framework and/or INTERSECT framework (e.g., for a reservoir or reservoirs) and the PIPESIM framework (e.g., for a surface network or surface networks). And, where CO2 is involved, a subsurface CO2 operational framework may be utilized.

As an example, a system can be a living integrated asset model (LAM) system that can may be operatively coupled to one or more computational frameworks. A LAM system can be for infrastructure utilized in one or more field operations that can aim to produce hydrocarbon fluids and/or inject and store CO2. As an example, a LAM system may be a living asset ensemble system that includes an ensemble of models or ensembles of models.

A LAM framework and associated workflow can provide solutions to maximize hydrocarbon production and/or CO2 injection and storage of a digitally enabled field, for example, by maintaining an underlying system that keeps models live/up-to-date with the current conditions of a reservoir or reservoirs (e.g., via data, sampling, etc.), and production and/or injection for the optimizing the asset (e.g., reserves of hydrocarbons, storage of CO2, etc.). An underlying system can acquire simulation data from current production to validate an integrated asset model, which couples single or multiple reservoirs, wells, networks, facilities and economic models (e.g., optionally an ensemble of ensembles). As an example, a LAM system can utilize and/or interact with various frameworks.

As mentioned, a workflow can include acquiring and/or analyzing seismic data, for example, by performing one or more seismic surveys. As an example, a seismic survey can acquire seismic data that can indicate changes in a reservoir, for example, consider reservoir filling, draining, compaction, etc. Where CO2 is injected, a seismic survey may help to understand where CO2 is being stored, whether fluid is be mixed, force to move, etc., and/or whether compaction, fracturing and/or expansion is occurring. As an example, a seismic survey may be utilized to determine whether CO2 is being adequately stored and/or whether leakage and/or a risk of leakage exists. As an example, seismic survey data may be utilized as part of a LAM system, which can facilitate CO2 related timings and operations.

A seismic survey can be defined with respect to a region of the Earth and, for example, a manner of acquisition of seismic data. As an example, a survey may be two-dimensional, three-dimensional, four-dimensional, etc. Dimensions include one or more spatial dimensions and optionally one or more temporal dimensions (e.g., repeating a survey for a region at different points in time). As to a 2D survey, a grid may be considered dense if the line spacing (e.g., of receivers) is less than about 400 m. As to a 3D spatial survey, in comparison to a 2D spatial survey, it may help to elucidate true structural dip (e.g., a 2D survey may give apparent dip), it may provide more and better stratigraphic information, it may provide a map view of reservoir properties, it may provide a better areal mapping of fault patterns and connections and delineation of reservoir blocks, it may provide better lateral resolution (e.g., 2D may suffer from a cross-line smearing, or Fresnel zone, problem). Other types of surveys include, for example, downhole and/or surface survey types. As an example, a survey that can utilize downhole equipment is a vertical seismic profile (VSP) survey. One or more of various types of surveys may be utilized in subsurface CO2 operational planning, execution, etc.

As to data sets, a 3D spatial seismic data set can be a cube or volume of data. As an example, a 2D spatial seismic data set can be a panel of data. To interpret 3D seismic data, a method can process the “interior” of the cube (e.g., seismic cube) using one or more processors of computing equipment. As an example, a 3D seismic data set can range in size from a few tens of megabytes to several gigabytes or more.

As to a 3D seismic cube, a point can have an (x, y, z) coordinate and a data value. A coordinate can be a distance from a particular corner of the cube. A 3D seismic data volume is like a room-temperature example (e.g., where temperature differs in a cube shaped room), however, rather than a height of a room, a height or vertical axis can be in terms of a two-way traveltime, which may be a proxy for depth. In such an example, the 3D seismic cube is still a spatial cube because the data therein correspond to the same survey where, rather than depth, two-way traveltime (TWT) is utilized, which, can be, in general, a proxy for depth. And, in contrast to room-temperature, data values can be seismic amplitudes (e.g., amplitudes of seismic energy waves). A 3D seismic data set can be, for example, a box full of electronically determined numbers where each number represents a measurement (e.g., amplitude of a seismic energy wave, etc.). In a 3D seismic data set, amplitudes may be rendered as data values in the form of one or more images for slices through the 3D seismic data set where, for example, in grayscale, dark and light image bands in the sections are related to rock boundaries.

Reflection seismology can be implemented as a technique that detects “edges” of materials in the Earth. An image generated utilizing reflection seismology can show such edges of materials, which can be equated to positions in the Earth such that one may know where an edge of a material is in the Earth. For example, where the edge corresponds to a hydrocarbon reservoir, a method can include drilling to the reservoir in a manner guided by the position of the edge. As an example, a drilling process can be manual, semi-automated or automated where positional information as to an edge of a material in the Earth can be utilized to guide drilling equipment that forms a bore in the Earth where the bore may be directed to the edge or to a region that is defined at least in part by the edge. Where reflection seismology is improved, such an “edge” may be detected more readily and/or with greater accuracy (e.g., resolution), which, in turn, can improve one or more field processes such as a drilling process.

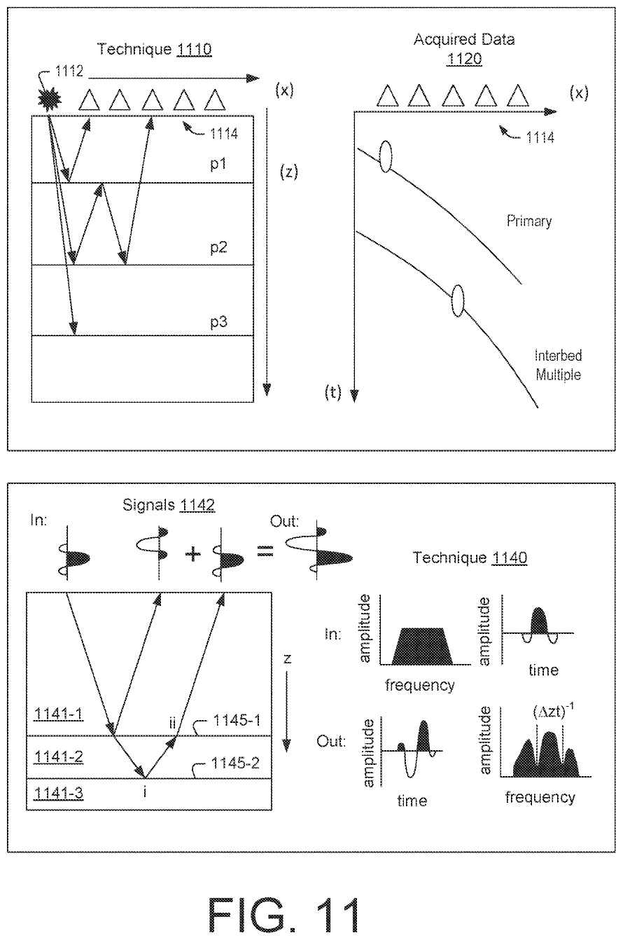

FIG. 11 shows an example of a technique 1110 and acquired data 1120, an example of a technique 1140 and signals 1142. As mentioned, a survey can include utilizing a source or sources and receivers. In the example technique 1110, a source 1112 is illustrated along with a plurality of receivers 1114 that are spaced along a direction defined as an inline direction x. Along the inline direction x, distances can be determined between the source 1112 and each of the receivers 1114.

A subsurface region being surveyed includes features such a surface and subsurface horizons p1, p2 and p3 where one or more of such structural features can be interfaces where elastic properties can differ such that seismic energy is at least in part reflected. For example, a horizon can be an interface that might be represented by a seismic reflection, such as the contact between two bodies of rock having different seismic velocity, density, porosity, fluid content, etc. In the example of FIG. 11, the technique 1110 is shown to generate seismic reflections, which can include singly reflected and multiply reflected seismic energy. The acquired data 1120 illustrate energy received by the receivers 1114 with respect to time, t, and their inline position along the x-axis. As shown, singly reflected energy can be defined as primary (or primaries) while multiply reflected energy can be defined as multiples such as surface multiples, interbed multiples (e.g., IM), etc.

A primary can be defined as a seismic event whose energy has been reflected once; whereas, a multiple can be defined as an event whose energy has been reflected more than once. With respect to seismic interpretation, whether manual, semi-automatic or automatic, various techniques may aim to enhance primary reflections to facilitate interpretation of one or more subsurface interfaces. In other words, multiples can be viewed as extraneous signal or noise that can interfere with an interpretation process. As an example, one or more method can utilize multiples to provide useful signals. For example, consider a seismic survey designed to increase seismic signal coverage of a subsurface region of the Earth through use of multiples.

In FIG. 11, the technique 1140 can include emitting energy with respect to time where the energy may be represented in a frequency domain, for example, as a band of frequencies. In such an example, the emitted energy may be a wavelet and, for example, referred to as a source wavelet which has a corresponding frequency spectrum (e.g., per a Fourier transform of the wavelet).

A wavelet can be a one-dimensional pulse defined by attributes such as, for example, amplitude, frequency and phase. A wavelet can originate as a packet of energy from a source point, having a specific origin in time, and be returned to one or more receivers as a series of events distributed in time and energy. The distribution is a function of velocity and density changes in the subsurface and the relative position of the source and receiver. Energy that returns cannot exceed what was input, so the energy in a received wavelet decays with time, for example, as more partitioning takes place at interfaces. Wavelets can also decay due to loss of energy as heat during propagation, which can be more extensive at higher frequencies. In various instances, received wavelets can tend to contain less high-frequency energy relative to low frequencies at longer traveltimes. Some wavelets are known by their shape and spectral content, such as the Ricker wavelet (e.g., a zero-phase wavelet such as the second derivative of the Gaussian function or the third derivative of the normal-probability density function).

As an example, a geologic environment may include layers 1141-1, 1141-2 and 1141-3 where an interface 1145-1 exists between the layers 1141-1 and 1141-2 and where an interface 1145-2 exists between the layers 1141-2 and 1141-3. As illustrated in FIG. 11, a wavelet may be first transmitted downward in the layer 1141-1; be, in part, reflected upward by the interface 1145-1 and transmitted upward in the layer 1141-1; be, in part, transmitted through the interface 1145-1 and transmitted downward in the layer 1141-2; be, in part, reflected upward by the interface 1145-2 (see, e.g., “i”) and transmitted upward in the layer 1141-2; and be, in part, transmitted through the interface 1145-1 (see, e.g., “ii”) and again transmitted in the layer 1141-1. In such an example, signals (see, e.g., the signals 1162) may be received as a result of wavelet reflection from the interface 1145-1 and as a result of wavelet reflection from the interface 1145-2. These signals may be shifted in time and in polarity such that addition of these signals results in a waveform that may be analyzed to derive some information as to one or more characteristics of the layer 1141-2 (e.g., and/or one or more of the interfaces 1145-1 and 1145-2). For example, a Fourier transform of signals may provide information in a frequency domain that can be used to estimate a temporal thickness (e.g., Δzt) of the layer 1141-2 (e.g., as related to acoustic impedance, reflectivity, etc.).

As explained, interbed multiple signals may be received by one or more receivers over a period of time in a manner that acts to “sum” their amplitudes with amplitudes of other signals. In such an example, the additional interbed signals may interfere with an analysis that aims to determine one or more characteristics of the layer 1141-2 (e.g., and/or one or more of the interfaces 1145-1 and 1145-2). For example, interbed multiple signals may interfere with identification of a layer, an interface, interfaces, etc. (e.g., consider an analysis that determines temporal thickness of a layer, etc.).

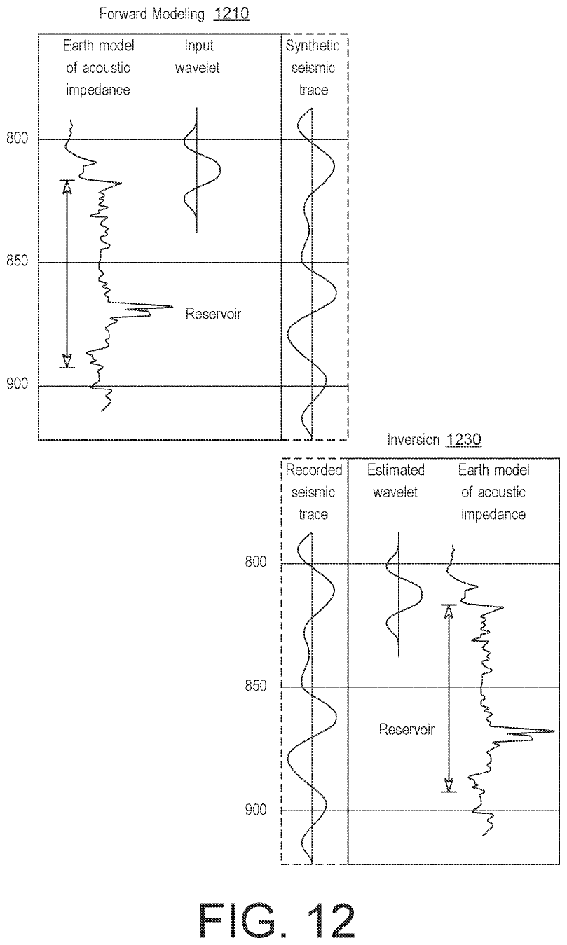

FIG. 12 shows an example of forward modeling 1210 and an example of inversion 1230 (e.g., an inversion or inverting). As shown, the forward modeling 1210 progresses from an earth model of acoustic impedance (e.g., acoustic properties) and an input wavelet to a synthetic seismic trace while the inversion 1230 progresses from a recorded seismic trace to an estimated wavelet and an Earth model of acoustic impedance. As an example, forward modeling can take a model of formation properties (e.g., acoustic properties computed using a subsurface CO2 operational framework, etc.) and combine such information with a seismic wavelength (e.g., a pulse) to output one or more synthetic seismic traces while inversion can commence with a recorded seismic trace, account for effect(s) of an estimated wavelet (e.g., a pulse) to generate values of acoustic impedance for a series of points in time (e.g., depth).

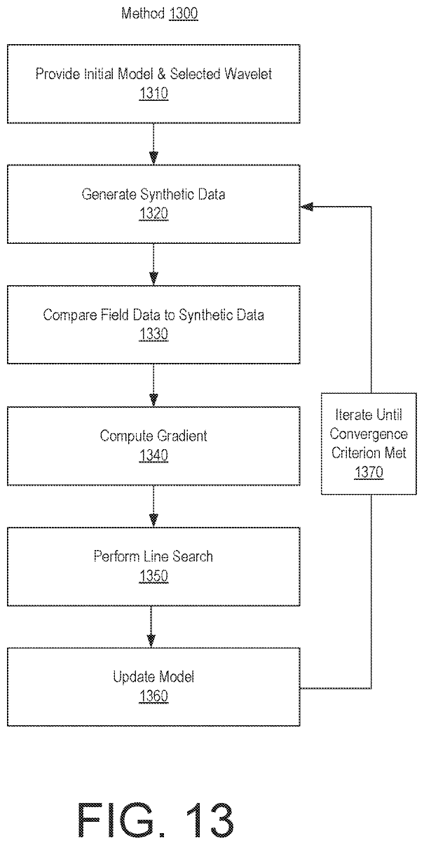

FIG. 13 shows an example of a method 1300 that can perform a full waveform inversion (FWI). As shown, the method 1300 includes a provision block 1310 for providing an initial model and a selected wavelet, a generation block 1320 for generating synthetic seismic data using the model and the wavelet, a comparison block 1330 for comparing the synthetic seismic data to field seismic data, a computation block 1340 for computing a gradient, a performance block 1350 for performing a line search and an update block 1360 for updating the model to provide an updated model, which may then be used by the generation block 1320. As shown, per an iteration block 1370, the method 1300 can proceed in an iterative manner until one or more convergence criteria are met, which may be based on error between synthetic seismic data and field seismic data. As an example, the method 1300 may be implemented by a computational framework such as, for example, the OMEGA framework.

While FIG. 13 shows an example of a FWI technique, other types of iterative inversion techniques include, for example, least-squares reverse time migration (LS-RTM) and image domain inversion (IDI).

As an example, where CO2 is present in a subsurface region that has been surveyed, a subsurface CO2 operational framework can provide for more accurate forward modeling and/or inversion. For example, such a framework can provide for more accurate acoustic properties for portions of the subsurface region that can include CO2, which may be in a subcritical state and/or supercritical state, whether substantially by itself and/or mixed with one or more other components (e.g., hydrocarbons, water, etc.). As an example, one or more images may be generated that may indicate the presence of CO2 in one or more states within a subsurface region. In such an example, one or more field operations may be controlled in an improved manner given locations and/or types of states within the subsurface region.

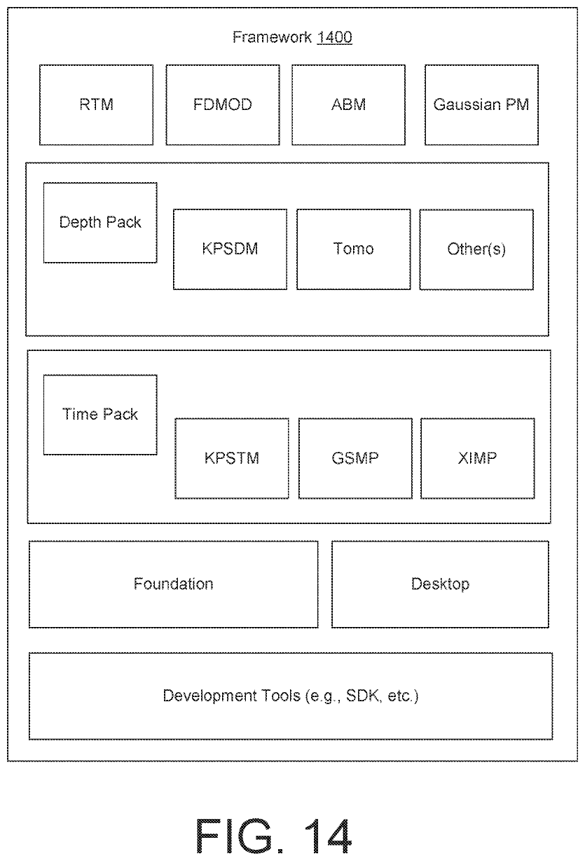

FIG. 14 shows an example of a computational framework 1400 that can include one or more processors and memory, as well as, for example, one or more interfaces. The blocks of the computational framework may be provided as instructions executable by one or more processors. The computational framework 1400 of FIG. 14 can include one or more features of the OMEGA framework (SLB, Houston, Texas), which includes finite difference modelling (FDMOD) features for two-way wavefield extrapolation modelling, generating synthetic shot gathers with and without multiples. The FDMOD features can generate synthetic shot gathers by using full 3D, two-way wavefield extrapolation modelling, which can utilize wavefield extrapolation logic matches that are used by reverse-time migration (RTM). A model may be specified on a dense 3D grid as velocity and optionally as anisotropy, dip, and variable density.

As shown in FIG. 14, the computational framework 1400 includes features for RTM, FDMOD, adaptive beam migration (ABM), Gaussian packet migration (Gaussian PM), depth processing (e.g., Kirchhoff prestack depth migration (KPSDM), tomography (Tomo)), time processing (e.g., Kirchhoff prestack time migration (KPSTM), general surface multiple prediction (GSMP), extended interbed multiple prediction (XIMP)), framework foundation features, desktop features (e.g., GUIs, etc.), and development tools.

The framework 1400 can include features for geophysics data processing. The framework 1400 can allow for processing various types of data such as, for example, one or more of: land, marine, and transition zone data; time and depth data; 2D, 3D, and 4D surveys; isotropic and anisotropic (TTI and VTI) velocity fields; and multicomponent data.

The framework 1400 can allow for transforming seismic, electromagnetic, microseismic, and/or vertical seismic profile (VSP) data into actionable information, for example, to perform one or more actions in the field for purposes of resource production, etc. The framework 1400 can extend workflows into reservoir characterization and earth modelling. For example, the framework 1400 can extend geophysics data processing into reservoir modelling by integrating with the DELFI environment and/or the PETREL framework via the Earth Model Building (EMB) tools, which enable a variety of depth imaging workflows, including model building, editing and updating, depth-tomography QC, residual moveout analysis, and volumetric common-image-point (CIP) pick QC. Such functionalities, in conjunction with the framework's depth tomography and migration algorithms, can produce accurate and precise images of the subsurface. The framework 1400 may provide support for field to final imaging, to prestack seismic interpretation and quantitative interpretation, from exploration to development.

As an example, the FDMOD component can be instantiated via one or more CPUs and/or one or more GPUs for one or more purposes. For example, consider utilizing the FDMOD for generating synthetic shot gathers by using full 3D, two-way wavefield extrapolation modelling, the same wavefield extrapolation logic matches that are used by reverse-time migration (RTM). FDMOD can model various aspects and effects of wave propagation. The output from FDMOD can be or include synthetic shot gathers including direct arrivals, primaries, surface multiples, and interbed multiples. The model can be specified on a dense 3D grid as velocity and optionally as anisotropy, dip, and variable density. As an example, survey designs can be modelled to ensure quality of a seismic survey, which may account for structural complexity of the model. Such an approach can enable evaluation of how well a target zone will be illuminated. Such an approach may be part of a quality control process (e.g., task) as part of a seismic workflow. As an example, a FDMOD approach may be specified as to size, which may be model size (e.g., a grid cell model size). Such a parameter can be utilized in determining resources to be allocated to perform a FDMOD related processing task. For example, a relationship between model size and CPUs, GPUs, etc., may be established for purposes of generating results in a desired amount of time, which may be part of a plan (e.g., a schedule) for a seismic interpretation workflow.

As an example, as survey data become available, interpretation tasks may be performed for building, adjusting, etc., one or more models of a geologic environment. For example, consider a vessel that transmits a portion of acquired data while at sea and that transmits a portion of acquired data while in port, which may include physically offloading one or more storage devices and transporting such one or more storage devices to an onshore site that includes equipment operatively coupled to one or more networks (e.g., cable, etc.). As data are available, options exist for tasks to be performed.

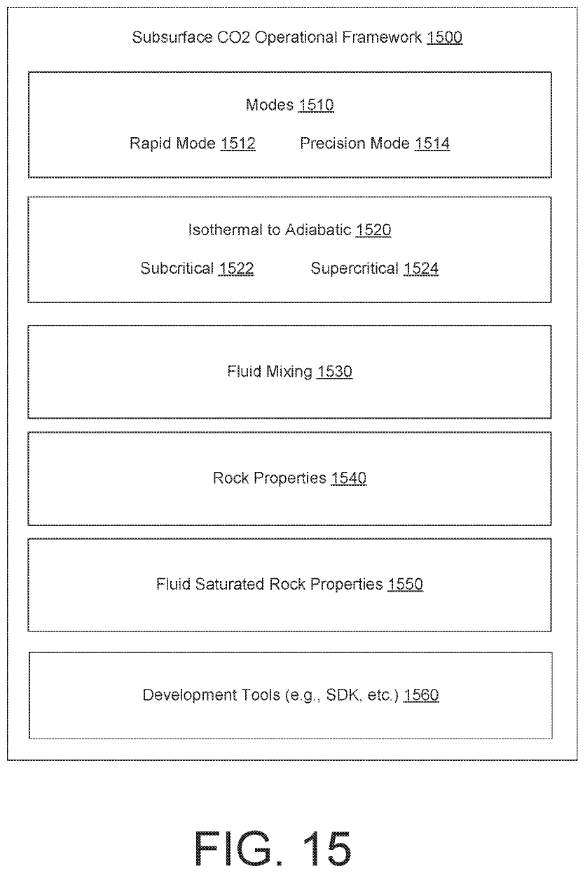

FIG. 15 shows an example of a subsurface CO2 operational framework 1500 that includes various components. As shown, the framework 1500 can include a mode component 1510 for implementation of a rapid mode 1512 and a precision mode 1514, which may execute more slowly than the rapid mode 1512. In such an example, the rapid mode 1512 may be suitable to expedite various workflows such as, for example, a realization workflow where various realizations are to be executed using a reservoir simulator; whereas, the precision mode 1514 may be more suitable for one or more seismic workflows where more accurate values of acoustic properties of regions that include CO2 are desired. As shown, the framework 1500 can include an isothermal to adiabatic component 1520, which can provide for subcritical 1522 and supercritical 1524 conversions of isothermal properties to adiabatic properties (e.g., consider compressibility) for regions that include CO2.

In the example of FIG. 15, the framework 1500 can include: a fluid mixing component 1530 for determining properties for fluids that can include CO2 along with one or more other types of fluid; a rock properties component 1540 that provides for rock properties of various types of rock (e.g., carbonate, clastic, etc.); a fluid saturated rock properties component 1550 that can determine properties of fluid saturated rock, which can include CO2; and a development tools component 1560, which may be in the form of a software development kit (SDK). As an example, the framework 1500 may be integrated into another framework (e.g., the OMEGA framework, the PETREL framework, the INTERSECT framework, etc.) and/or be available via one or more APIs, etc.

As an example, one or more types of equations, procedures, etc., may be implemented by the framework 1500. For example, as to rock physics modeling, consider the Gassmann equation, which finds use in geophysics and seismic workflows. The Gassmann equation can be utilized as part of a fluid substitution model from a known parameter. For example, given an initial set of velocities and densities, corresponding to rock with an initial set of fluids, the Gassmann equation can compute velocities and densities of the rock with another set of fluid. In such an example, the velocities may be measured from well logs, but might also come from a theoretical model. As explained herein, velocities, particularly where CO2 is present as a fluid in rock (e.g., rock pores, etc.), may be computed in an isothermal to adiabatic manner. As explained, a speed of sound equation may be utilized in an isothermal to adiabatic conversion or transformation.

In seismic analysis, compressional (P-wave) and shear (S-wave) velocities along with densities directly control seismic response of a reservoir at each particular location. Consider that dry and water saturated P- and S-wave velocities of sandstones are a function of differential pressure. P-wave velocity increases, while S-wave velocity decreases slightly with water saturation. However, both P- and S-wave velocities may not be the best indicators for a fluid saturation effect. This is a function of coupling between P- and S-wave through the shear modulus and bulk density. In contrast, if bulk and shear modulus are plotted as functions of pressure, the water-saturation effect shows the following: bulk modulus increases about 50 percent; and shear modulus remains almost constant. Bulk modulus tends to be more strongly sensitive to water saturation. The bulk volume deformation produced by a passing seismic wave results in a pore volume change, and causes a pressure increase of pore fluid (water). This has the effect of stiffening the rock and increasing the bulk modulus. Shear deformation usually does not produce pore volume change, and differing pore fluids often do not affect shear modulus. The Gassmann, as well as other types of equations, can provide a model to estimate fluid saturation effect on bulk modulus. In various instances, seismic frequencies may be high such that Gassmann's equation may be less accurate. For example, at high frequencies, pore pressures may not have enough time to reach equilibrium and rock may remain unrelaxed or partially relaxed. As an example, one or more compliance types of models or equations may be implemented (e.g., consider excess compliance, etc.).

As an example, a model or equation may be selected based on frequency utilized in a seismic data acquisition process. For example, downhole sonic can utilize a higher frequency than surface seismic. As an example, the framework 1500 can provide components that may be extendible and/or adapted for use with one or more types of workflows. As an example, where CO2 is present and seismic relevant, the framework 1500 may be implemented to improve a workflow, whether the workflow is a surface seismic, downhole seismic, etc. As an example, a downhole study may be a vertical seismic profile (VSP), a distributed acoustic sensing (DAS) study, etc.

As explained, a workflow can involve monitoring reservoir behavior, including reservoir simulation and history-matching with production rates and/or injection rates and pressure. In a 4D seismic study, properties can evolve over time spatially. As an example, the framework 1500 may be implemented in a 4D seismic workflow to compute properties related to CO2, for example, with respect to storage stability, injection, etc. As an example, fluid or pressure changes may occur outside of a reservoir where such changes may be observed on seismic time-lapse studies. Such changes may include: variation in the fluid and rock velocities because of changes in pore pressure (therefore, also in effective or differential pressure); changes in rock stress because of deformation of the overburden and sideburden surrounding the reservoir; and/or changes in fluid saturation in nearby, reservoirs because of changes in pore pressure (dropping below bubble point, raising due to CO2 injection, etc.), which may be communicated through the subsurface.

As to rock velocity properties, in a compacting basin with neither lateral deformation nor tectonic stresses, the vertical stress will be largest. Lateral stresses may be developed in a basin as sediments are buried and compacted but are constrained horizontally. Both uniform hydrostatic and unequal lithostatic stress conditions exist. Where CO2 injection and storage are performed, some behaviors may differ from those of a production scenario; noting that both injection and production may be performed.

As an example, a workflow may complement seismic information with multiphysics (e.g., gravity, magnetics, electromagnetics, and magnetotellurics) data. For example, consider electromagnetic (EM) services, which can include passive magnetotelluric (MT) and active controlled-source electromagnetic (CSEM). A workflow may integrate seismic data and other measurements for subsurface imaging and reservoir characterization studies via simultaneous or petrophysical joint inversions. Such an approach can reduce uncertainty of solutions through more fully integrated models.

As an example, the framework 1500 may receive simulation results from a simulator as input. For example, consider simulation results that indicate composition as spatially distributed within a reservoir. In such an example, the framework 1500 can utilize the composition results to determine spatially distributed acoustic properties suitable for use in one or more seismic workflows. As explained, a simulator may utilize one or more types of EoS (e.g., Peng Robinson, etc.) and/or one or more flash computations (e.g., flash packages, etc.). As explained, once isothermal compressibility is determined, it may be utilized to determine adiabatic compressibility, which may be implemented in one or more seismic workflows. Such an approach can be a Sim2Seis approach.

As an example, a workflow may include using simulation results from a simulator run or runs or may not include using such results. As an example, a method may be 1D or multidimensional. As an example, a method can include selecting and applying one or more EoSs at particular pressure and temperature conditions (e.g., as may be associated with a phase diagram or phase diagrams). In such an example, flash computations may be utilized to get mole fraction and vapor and liquid phases. Flash results can provide for isothermal compressibility and density, which can be utilized to compute the heat capacity ratio (γ), and then adiabatic compressibility, which provides the acoustic velocity of the fluid (e.g., speed of sound). As explained, such an approach may be implemented for pure components and/or mixtures of components.

As explained, where a flow simulator is implemented, it can already provide one or more EoSs, which may provide for computation of the heat capacity ratio (γ) and isothermal compressibility. In such an example, the isothermal compressibility may be utilized along with γ to determine adiabatic compressibility and hence acoustic velocity of fluid, whether pure or mixed. As an example, a simulator such as, for example, the INTERSECT simulator, may provide for output of various values, which may be utilized by the framework 1500. As an example, the INTERSECT simulator may be operatively coupled to the framework 1500 such that upon running the INTERSECT simulator, appropriate acoustic parameters can be output and available for one or more seismic workflows. As an example, a reservoir simulation workflow and a seismic workflow may be linked where the framework 1500 can be implemented to provide for CO2 related property computations. As an example, a simulator approach can be 3D or 4D; whereas, an approach without use of a simulator may in various instances be of a lesser dimension (e.g., 1D). As an example, the framework 1500 may be implemented in an online, automated manner as integrated into a workflow or workflows.

As an example, the framework 1500 may operate using one or more types of coding. For example, consider JSON, PYTHON, etc., which may provide for a relatively lightweight implementation in terms of operability with one or more other frameworks and/or environments (e.g., consider the DELFI environment). As an example, the framework 1500 may be implemented as a post-processing procedure using output of a reservoir simulator and/or one or more other types of simulators (e.g., surface network, etc.). In such an example, the results of the simulator may be utilized to computer appropriate acoustic properties for use by one or more workflows. As an example, a platform such as the DATAIKU platform may be utilized, which includes various data science capabilities (e.g., programmable artificial intelligence, machine learning, statistics, computational formulas, libraries, etc.). As another example, consider the TIBCO SPOTFIRE platform, which may be integrated with the DATAIKU platform.

As an example, a workflow can involve generating a rock physics model for use in a simulator for fluid flow simulation where the rock physics model may be calibrated using one or more approaches, which can include machine learning, field data, laboratory data, etc. In such an example, the fluid flow simulation can output values that can be utilized to compute acoustic property values for use in one or more seismic workflows. As an example, the framework 1500 can include features to handle rock physics models and adjustments thereto, which may be based on field and/or laboratory data, optionally in a real-time manner or on-demand. For example, the framework 1500 may be operatively coupled to one or more databases, networks, etc., for receipt of data.

As an example, the framework 1500 may utilized to generate data for storage, for example, as a database, data table, proxy model, etc. As an example, the rapid mode 1512 may utilize such an approach. For example, the rapid mode 1512 may utilize a proxy model, which may be a model generated from data using one or more types of fitting routines, optionally one or more types of machine learning (ML) models. In such an example, a proxy model may have input tailored for one or more workflows (e.g., consider realization studies for sensitivity analysis, etc.). As to the precision mode 1514, it may be implemented where precision and/or accuracy are concerns, for example, in a history matching workflow and/or various seismic workflows.

As an example, an ML model may be trained using data generated through use of one or more EoSs, laboratory data and/or field data. In such an approach, the data may be more accurate than EoS results. As an example, one or more EoSs may be utilized to fill-in gaps that may exist in data. As an example, an ML model approach can utilize a hybrid of data-driven (e.g., lab and/or field data) and physics-based results (e.g., a physics-based EoS approach). As an example, a physics-driven neural network and/or other approach may be utilized for ML model generation.

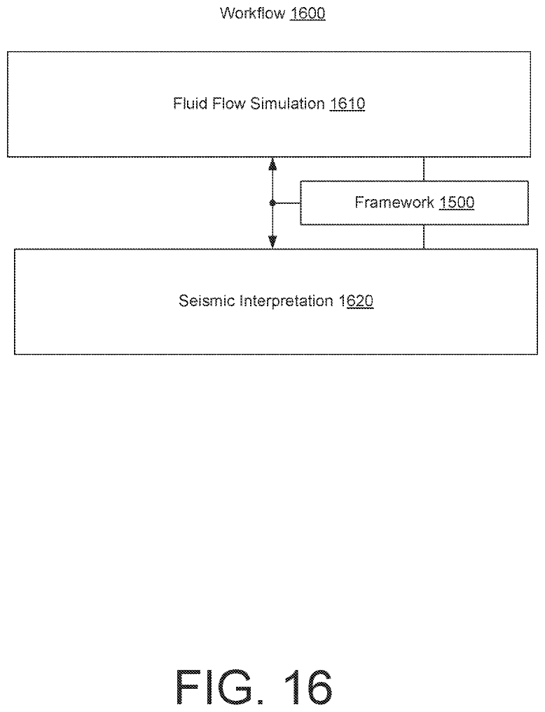

FIG. 16 shows an example of a workflow 1600 that can include a fluid flow simulation 1610 as performed by one or more simulators and a seismic interpretation 1620, which may involve forward modeling and/or inversion. In the workflow 1600, where CO2 injection and storage are involved, the framework 1500 may be implemented to provide acoustic properties for purposes of the seismic interpretation 1620. As explained, seismic interpretation can provide for localization of subsurface features, which may include structural features, fluid features, etc. As explained, improved characterization of a subsurface region can improve field operations with respect to at least a portion of the subsurface region, which may include, for example, one or more CCS types of operations.

As mentioned, one or more ML model techniques may be utilized, which may be for regression (prediction) and/or for classification. As an example, a combined ML model for regression (prediction) and classification can be for determining the age of an abalone from physical details, where predicting the number of rings of the abalone is a proxy for the age of the abalone (e.g., age can be predicted as both a numerical value (in years) or a class label (ordinal year as a class)). In various examples, a trained ML model may output probability information. For example, consider a probability that input belongs to a particular class.

As to some types of ML models, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network (CNN), stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine learning model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, the TENSORFLOW framework (Google LLC, Mountain View, CA) may be implemented, which is an open-source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system-based platforms.

TENSORFLOW computations can be expressed as stateful dataflow graphs; noting that the name TENSORFLOW derives from the operations that such neural networks perform on multidimensional data arrays. Such arrays can be referred to as “tensors”.

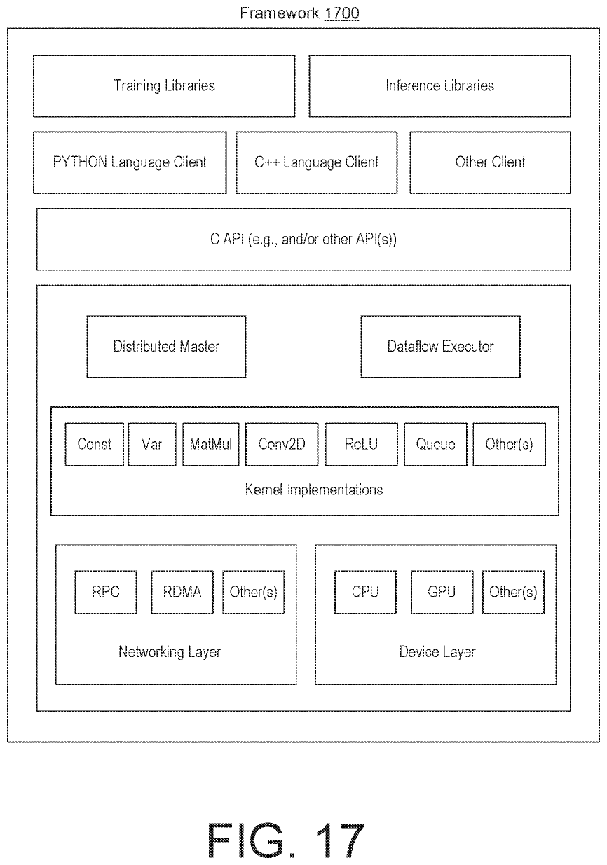

FIG. 17 shows an architecture 1700 of a framework such as the TENSORFLOW framework. As shown, the architecture 1700 includes various features. As an example, in the terminology of the architecture 1700, a client can define a computation as a dataflow graph and, for example, can initiate graph execution using a session. As an example, a distributed master can prune a specific subgraph from the graph, as defined by the arguments to “Session.run( )”; partition the subgraph into multiple pieces that run in different processes and devices; distributes the graph pieces to worker services; and initiate graph piece execution by worker services. As to worker services (e.g., one per task), as an example, they may schedule the execution of graph operations using kernel implementations appropriate to hardware available (CPUs, GPUs, etc.) and, for example, send and receive operation results to and from other worker services. As to kernel implementations, these may, for example, perform computations for individual graph operations.

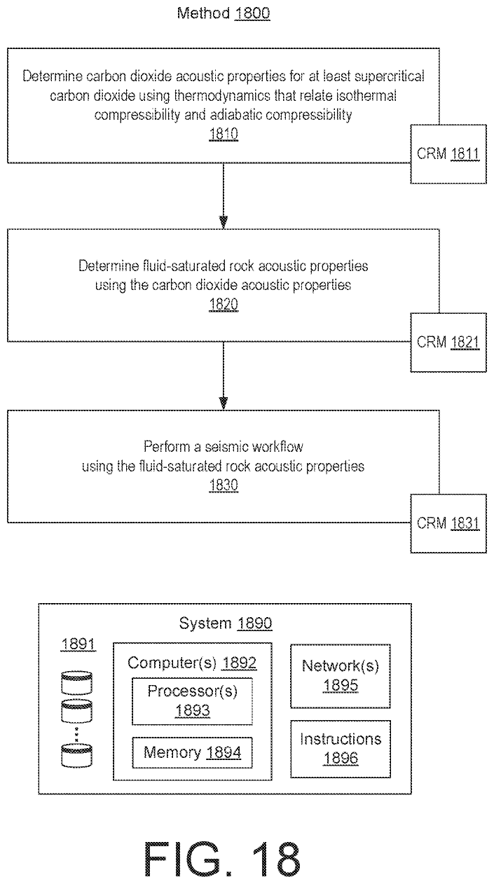

FIG. 18 shows an example of a method 1800 and an example of a system 1890. As shown, the method 1800 includes a determination block 1810 for determining carbon dioxide acoustic properties for at least supercritical carbon dioxide using thermodynamics that relate isothermal compressibility and adiabatic compressibility; a determination block 1820 for determining fluid-saturated rock acoustic properties using the carbon dioxide acoustic properties; and a performance block 1830 for performing a seismic workflow using the fluid-saturated rock acoustic properties.

The method 1800 is shown as including various computer-readable storage medium (CRM) blocks 1811, 1821, and 1831 that can include processor-executable instructions that can instruct a computing system, which can be a control system, to perform one or more of the actions described with respect to the method 1800.

In the example of FIG. 18, the system 1890 includes one or more information storage devices 1891, one or more computers 1892, one or more networks 1895 and instructions 1896. As to the one or more computers 1892, each computer may include one or more processors (e.g., or processing cores) 1893 and memory 1894 for storing the instructions 1896, for example, executable by at least one of the one or more processors 1893 (see, e.g., the blocks 1811, 1821, and 1831). As an example, a computer may include one or more network interfaces (e.g., wired or wireless), one or more graphics cards, a display interface (e.g., wired or wireless), etc.

As an example, a method can determining carbon dioxide acoustic properties for at least supercritical carbon dioxide using thermodynamics that relate isothermal compressibility and adiabatic compressibility; determining fluid-saturated rock acoustic properties using the carbon dioxide acoustic properties; and performing a seismic workflow using the fluid-saturated rock acoustic properties. In such an example, the thermodynamics can include a relationship between a heat capacity at constant pressure and a heat capacity at constant volume. For example, the relationship can be a heat capacity ratio of the heat capacity at constant pressure divided by the heat capacity at constant volume.

As an example, carbon dioxide acoustic properties can depend on speed of sound in carbon dioxide.

As an example, a method can include receiving simulation results from a fluid flow simulator, where the simulation results indicate spatially distributed fluid saturations in rock, and where the method can include determining fluid-saturated rock acoustic properties utilizing at least a portion of the spatially distributed fluid saturations in the rock.

As an example, a method can include determining fluid-saturated rock acoustic properties by selecting at least one model for representing fluid in rock. In such an example, the selecting can depend on type of rock. As an example, the Gassmann equation and/or one or more other equations may be selected.

As an example, a method can include determining fluid-saturated rock acoustic properties by implementing one or more mixing techniques for a fluid mixture that comprises carbon dioxide.

As an example, a method can include determining carbon dioxide acoustic properties by accessing a subsurface carbon dioxide operational framework. In such an example, the subsurface carbon dioxide operation framework can include multiple modes of operation that can include a rapid mode and a precision mode. In such an example, the rapid mode can utilize one or more proxy models.

As an example, a seismic workflow can include forward modeling using fluid-saturated rock acoustic properties to generate one or more seismic responses (e.g., for a region that includes CO2, etc.).

As an example, a seismic workflow can include an inversion or multiple inversions. For example, consider a full waveform inversion (FWI), which may be performed iteratively. In such an example, the FWI may be operatively coupled to a framework that can provide acoustic properties.

As an example, a seismic workflow can be a four-dimensional seismic workflow that utilizes four-dimensional seismic data acquired for a reservoir subjected to CO2 injection. In such an example, a method can include controlling the CO2 injection based at least in part on interpretation of the four-dimensional seismic data, where the interpretation is based at least in part on the fluid-saturated rock acoustic properties.

As an example, fluid-saturated rock acoustic properties can include spatially distributed acoustic velocities. As an example, fluid-saturated rock acoustic properties can include spatially distributed bulk moduli.

As an example, a system can include a processor; a memory accessibly by the processor; and instructions stored in the memory and executable by the processor to instruct the system to: determine carbon dioxide acoustic properties for at least supercritical carbon dioxide using thermodynamics that relate isothermal compressibility and adiabatic compressibility; determine fluid-saturated rock acoustic properties using the carbon dioxide acoustic properties; and perform a seismic workflow using the fluid-saturated rock acoustic properties.

As an example, one or more computer-readable storage media can include processor-executable instructions wherein the processor-executable instructions comprise instructions to instruct a computing system to: determine carbon dioxide acoustic properties for at least supercritical carbon dioxide using thermodynamics that relate isothermal compressibility and adiabatic compressibility; determine fluid-saturated rock acoustic properties using the carbon dioxide acoustic properties; and perform a seismic workflow using the fluid-saturated rock acoustic properties.

As an example, a computer program product can include one or more computer-readable storage media that can include processor-executable instructions to instruct a computing system to perform one or more methods and/or one or more portions of a method.

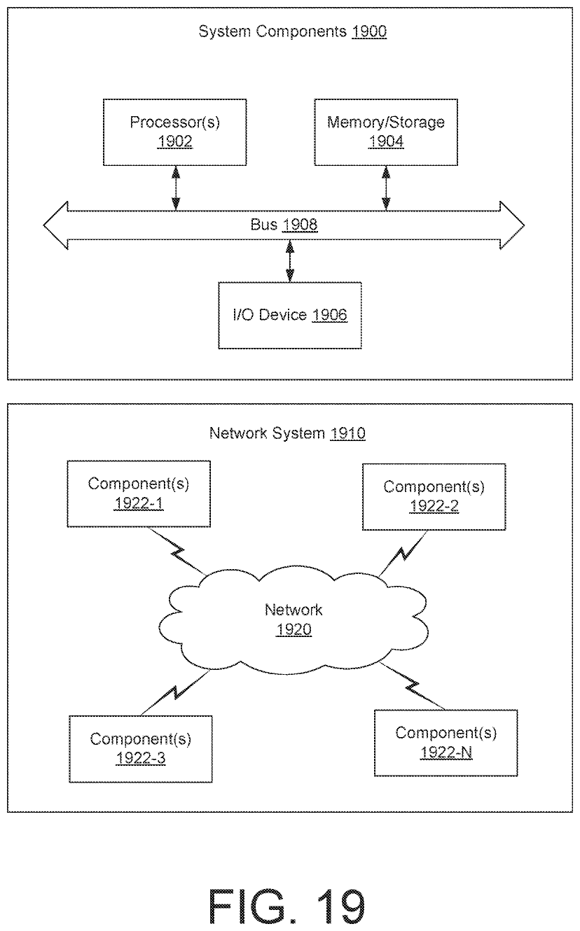

FIG. 19 shows components of an example of a computing system 1900 and an example of a networked system 1910 with a network 1920. The system 1900 includes one or more processors 1902, memory and/or storage components 1904, one or more input and/or output devices 1906 and a bus 1908. In an example embodiment, instructions may be stored in one or more computer-readable media (e.g., memory/storage components 1904). Such instructions may be read by one or more processors (e.g., the processor(s) 1902) via a communication bus (e.g., the bus 1908), which may be wired or wireless. The one or more processors may execute such instructions to implement (wholly or in part) one or more attributes (e.g., as part of a method). A user may view output from and interact with a process via an I/O device (e.g., the device 1906). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1910. The network system 1910 includes components 1922-1, 1922-2, 1922-3, . . . 1922-N. For example, the components 1922-1 may include the processor(s) 1902 while the component(s) 1922-3 may include memory accessible by the processor(s) 1902. Further, the component(s) 1922-2 may include an I/O device for display and optionally interaction with a method. The network 1920 may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
determining carbon dioxide acoustic properties for at least supercritical carbon dioxide using thermodynamics that relate isothermal compressibility and adiabatic compressibility;
determining fluid-saturated rock acoustic properties using the carbon dioxide acoustic properties; and
performing a seismic workflow using the fluid-saturated rock acoustic properties.

2. The method of claim 1, wherein the thermodynamics comprise a relationship between a heat capacity at constant pressure and a heat capacity at constant volume.

3. The method of claim 2, wherein the relationship is a heat capacity ratio of the heat capacity at constant pressure divided by the heat capacity at constant volume.

4. The method of claim 1, wherein the carbon dioxide acoustic properties depend on speed of sound in carbon dioxide.

5. The method of claim 1, comprising receiving simulation results from a fluid flow simulator, wherein the simulation results indicate spatially distributed fluid saturations in rock, and wherein the determining fluid-saturated rock acoustic properties utilizes at least a portion of the spatially distributed fluid saturations in the rock.

6. The method of claim 1, wherein the determining fluid-saturated rock acoustic properties comprises selecting at least one model for representing fluid in rock.

7. The method of claim 6, wherein the selecting depends on type of rock.

8. The method of claim 6, wherein the selecting selects the Gassmann equation.

9. The method of claim 1, wherein the determining fluid-saturated rock acoustic properties comprises implementing one or more mixing techniques for a fluid mixture that comprises carbon dioxide.

10. The method of claim 1, wherein the determining carbon dioxide acoustic properties comprises accessing a subsurface carbon dioxide operational framework.

11. The method of claim 10, wherein the subsurface carbon dioxide operation framework comprises multiple modes of operation that comprise a rapid mode and a precision mode.

12. The method of claim 11, wherein the rapid mode utilizes one or more proxy models.

13. The method of claim 1, wherein the seismic workflow comprises forward modeling using the fluid-saturated rock acoustic properties to generate one or more seismic responses.

14. The method of claim 1, wherein the seismic workflow comprises an inversion.

15. The method of claim 1, wherein the seismic workflow comprises a four-dimensional seismic workflow that utilizes four-dimensional seismic data acquired for a reservoir subjected to CO2 injection.

16. The method of claim 15, comprising controlling the CO2 injection based at least in part on interpretation of the four-dimensional seismic data, wherein the interpretation is based at least in part on the fluid-saturated rock acoustic properties.

17. The method of claim 1, wherein the fluid-saturated rock acoustic properties comprise spatially distributed acoustic velocities.

18. The method of claim 1, wherein the fluid-saturated rock acoustic properties comprise spatially distributed bulk moduli.

19. A system comprising:
a processor;
a memory accessibly by the processor; and
instructions stored in the memory and executable by the processor to instruct the system to:
determine carbon dioxide acoustic properties for at least supercritical carbon dioxide using thermodynamics that relate isothermal compressibility and adiabatic compressibility;
determine fluid-saturated rock acoustic properties using the carbon dioxide acoustic properties; and
perform a seismic workflow using the fluid-saturated rock acoustic properties.

20. One or more computer-readable storage media comprising processor-executable instructions wherein the processor-executable instructions comprise instructions to instruct a computing system to:
determine carbon dioxide acoustic properties for at least supercritical carbon dioxide using thermodynamics that relate isothermal compressibility and adiabatic compressibility;
determine fluid-saturated rock acoustic properties using the carbon dioxide acoustic properties; and
perform a seismic workflow using the fluid-saturated rock acoustic properties.
